(19) United States
(12) Patent Application Publication
(10) Pub. No.: US 2014/0150875 A1
(43) Pub. Date: Jun. 5, 2014

(54) HOSE DEPLOYMENT DEVICE

(71) Applicants: Sebastian Jacobs, Erskineville, NSW (AU); Mary Jacobs, Yerrinbool, NSW (AU)

(72) Inventors: Sebastian Jacobs, Erskineville, NSW (AU); Mary Jacobs, Yerrinbool, NSW (AU)

(73) Assignee: INNOVATION REALISATION PTY LTD, Erskineville, NSW (AU)

(21) Appl. No.: 13/983,454

(22) PCT Filed: Feb. 3, 2012
(86) PCT No.: PCT/AU2012/000099

§ 371 Date: Sep. 25, 2013

(30) Foreign Application Priority Data
Feb. 4, 2011 (AU) 2011900367
Feb. 4, 2011 (AU) 2011900368

(51) Int. Cl. F16L 3/16

(52) U.S. Cl. CPC F16L 3/16
USPC 137/1; 138/106

(57) ABSTRACT

A hose deployment device (1) including a base (3, 300) having sides (4, 400) which in a contracted configuration secure together to define a space to receive a hose (10, 100). The sides (4, 400) in an expanded configuration extend outwardly away from each outer to provide an opening through which the hose (10, 100) can move. Fastening means secure a hose inlet valve and a hose outlet nozzle (27) to the device. Strap means secure a hose to the base in the contracted configuration. Upon application of a fluid pressure to the inlet valve the hose expands urging the strap means to release the hose from the base.

### FIELD OF THE INVENTION

The present invention relates to a hose deployment device and in particular to a device to rapidly and reliably deploy a lay flat expanding hose in a linear or coiled fashion.

### BACKGROUND OF THE INVENTION

Hoses are used throughout the world to transport fluid between different locations. For example, industrial hoses are typically used between various machines and in process plants. Hoses are also used around swimming pools, gardens and by fire fighters and other emergency personnel to extinguish fires.

Fire fighters and emergency personnel will often carry their own hoses to a location where a fire is to be extinguished. A fire hose is very easy to manipulate while dry. As soon as water is introduced into the hose, it expands and becomes harder, more strenuous and time consuming to maneuver and direct the resultant water stream. To be effective the hose must allow the water to flow at the optimum flow rate. To this end a hose should not be pressurized with water until it is correctly laid out. It takes a fire fighter a considerable amount of time to correctly deploy a hose in a confined space i.e. fire stairs and terrace style courtyards or the like. The extra time causes significant delays in extinguishing fixes and rescuing people.

Typically, three factors contribute to the correct deployment of a fire hose, Firstly, hose preparation or how a hose is folded is critically important as quick and accurate deployment is required. A fire fighter needs to avoid kinking and needs lineal space usually at least a minimum of 15 meters to deploy the hose. Secondly, hose deployment or the functionality of the hose is important as it effects the nature of the water travelling through the hose. Lastly, the hose lay or the nature the hose is made ready is important as the hose needs to be laid straight out along a surface and organized and this can be particularly difficult to achieve when fighting a fire at night or in heavy smoke as something as simple as a car tyre can interrupt the unrolling hose. Also, a fire fighter or other emergency personnel often wear protective equipment making correct hose deployment challenging.

Common to all events where hose lay is required; there are two standard needs that must be met. The first being a need to ‘stretch’ a hose from a pressurised water supply to a point at or near to the entry of a fire where it can then be connected to the second standard hose lay. A hose ready to deploy into a room, compartment or area involved in the fire. There is a need for a device that stores and deploys, ‘stretches’ or ‘Lays’ a hose from the pressurised water supply to a point at or near to the entry point of a file or incident.

In an attempt to address the above problems some fire fighters use a High Rise or Remote Access Kit to convey hose to a hydrant in a point too far from the fire truck. However, the High Rise or Remote Access Kit is simply a typical backpack that is large enough to hold the equipment required and does not assist the fire fighter in the correct deployment of a hose. When rolling out a hose a linear space of 15 meters is required. When deploying a hose from a hydrant in a stairwell of a high rise building the hose needs to be rolled down the stairs to achieve the 15 meters. This adds significant weight for the fire fighter to move when the hose is pressurized with water.

In U.S. Pat. No. 6,267,319 is shown an apparatus and method of rolling a fire hose. However, this device rolls the hose in a coil about a large fixed metal structure. It is not in a pack, bag or other easily portable device. The structure is also heavy, requires considerable storage space and still requires manual handling of deployed and undeployed fire hose.

Accordingly, there is a need for a device to assist a fire fighter or other emergency personnel to easily and quickly prepare, deploy and lay a fire hose or the like in a confined space. In particular, to reliably deploy a hose with no kinks or tangles while increasing the speed of water exiting the hose, while decreasing the physical exertion of the fire fighter or other emergency personnel.

### OBJECT OF THE INVENTION

It is an object of the present invention to substantially overcome or at least ameliorate one or more of the disadvantages of the prior art, or to at least provide a useful alternative.

### SUMMARY OF THE INVENTION

There is firstly disclosed herein a hose deployment device including:

a base having sides which in a contracted configuration secure together to define a space to receive a hose, the sides in an expanded configuration extend outwardly away from each other to provide an opening through which the hose can move;

fastening means to secure a hose inlet valve and a host outlet nozzle to said device;

strap means to secure a hose to the base in the contracted configuration; and

whereby upon application of a fluid pressure to said inlet valve, said hose expands urging said strap means to release said hose from said base, said hose urging said sides away from each other deploying said hose into a coiled configuration for use by a user.

Preferably, said coiled configuration is within a 2 m² area.

Preferably, said hose is deployed from said device in a coiled configuration until such time as a user moves the hose away from the device.

Preferably, pressure in said inlet valve to release said strap means is more than 400 kPa.

There is further disclosed herein a method of deploying a hose including the steps of:

carrying a hose deployment device as set out above to a Location of use;

placing the device on a surface;

attaching a water source to said water inlet valve;

pressurizing said hose so that said hose expands;

said pressurized hose, urging said strap means to release said hose from said hose, said hose urging said sides away from each other deploying said hose in a coiled configuration;

a user moving said outlet nozzle towards a fire to be extinguished, straightening said hose.

There is firstly disclosed herein a hose deployment device including:

a base having sides which. in a contracted configuration secure together to define a space to receive a hose, the sides in an expanded configuration extend outwardly away from each other to provide an opening through which the hose can move;

fastening means to secure a hose inlet valve and a hose outlet valve to said device;

strap means to secure the hose to the base in the contracted configuration;

securing straps connected to said fastening means and strap means; and

whereby upon a user urging said securing straps said hose valves are released from said device and said hose can be deployed.

Preferably, said device m the contracted configuration can be deployed in any space the size of the device or greater.

Preferably, said hose is adapted to be deployed from said base in a linear configuration to avoid kinking.

Preferably, including strap means to secure said sides together.

Preferably, said device includes means to attach said device to a user.

Preferably, said sides in the contracted configuration overlap each other.

Preferably, said strap means includes a hook and loop type fastener.

In combination, a device according to the above and a hose to be deployed by said device.

There is further disclosed herein a method of deploying a hose including the steps of:

carrying a hose deployment device to a location of use;

placing the device on a surface;

opening an inlet/outlet valve securing strap on said device;

removing the inlet/outlet valve of contained hose; and

manually removing hose from an end of said device to deploy said hose.

### BRIEF DESCRIPTION OF THE DRAWINGS

Preferred embodiments of the invention will now be described, by way of examples only, with reference to the accompanying drawings, wherein:

FIG. 1 shows a first embodiment hose deployment device in a contracted configuration ready to be carried by a user;

FIG. 2 is shows a hose deployment device of FIG. 1 ready to be used;

FIG. 3 shows the device of FIG. 2;

FIG. 4 shows the device of FIG. 2;

FIG. 5 shows the device of FIG. 2;

FIG. 6 shows the device of FIG. 2;

FIG. 7 shows the device of FIG. 2 with equipment storage pocket and release mechanism in open position;

FIG. 8 shows the device of FIG. 2 with equipment storage pocket and release mechanism with hose inlet valve secured; and

FIG. 9 shows the device of FIG. 2 with equipment storage pocket and release mechanism in secured position ready to be carried by the user.

FIG. 10 is shows a second embodiment hose deployment device in a contracted configuration ready to be carried by a user;

FIG. 11 shows a hose deployment device of FIG. 10 demonstrating the stowage of the tail of hose as it exits the hose deployment device;

FIG. 12 shows the device of FIG. 11 closed with uncovered hose tails;

FIG. 13 shows the device of FIG. 12 now closed;

FIG. 14 shows the device of FIG. 11 with hose flaked or concertina folded in the hose deployment device;

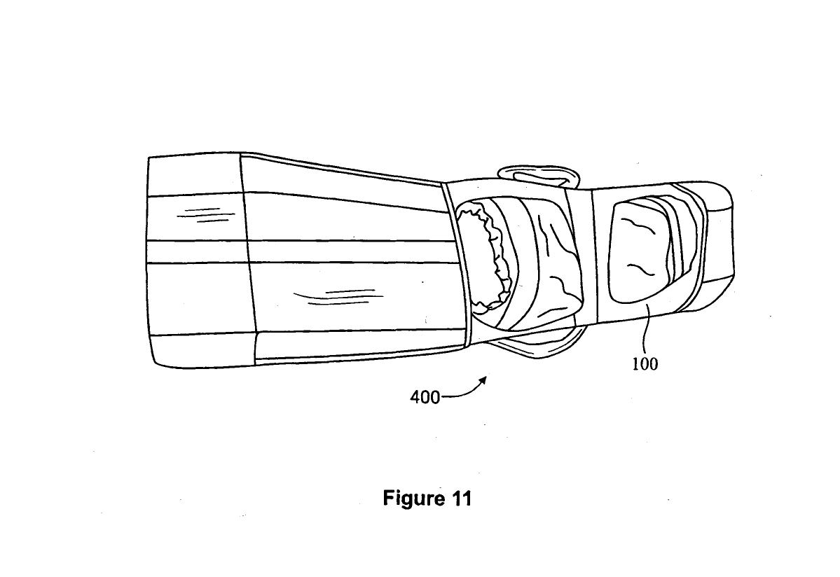

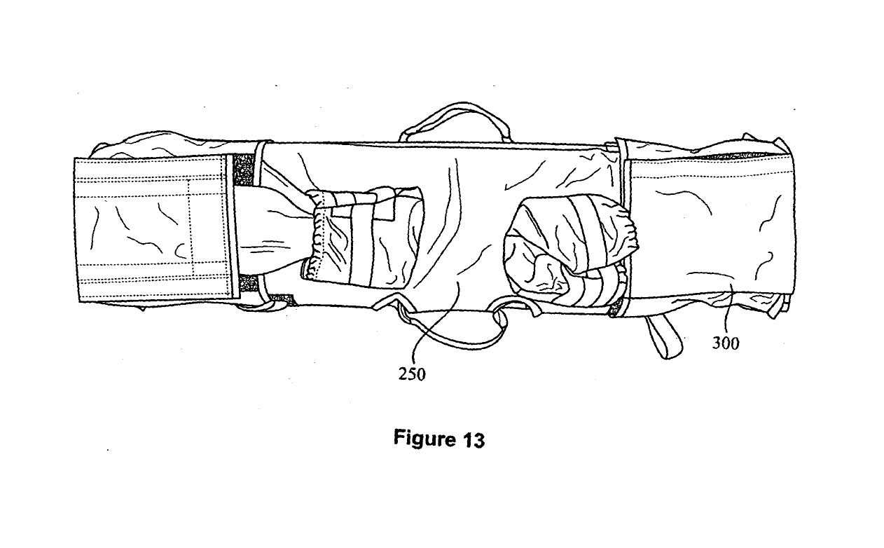

FIG. 13 shows the device of FIG. 11 complete with gated breeching piece;

FIG. 16 shows the device of FIG. 11 with the hose tail containment flap;

FIG. 17 shows an exterior of a third embodiment hose deployment device in a deployed configuration;

FIG. 18 shows an interior view of the hose deployment device of FIG. 17;

FIG. 19 shows a housing on the exterior of the hose deployment device of FIG. 17 in a contacted configuration;

FIG. 20 shows the housing of FIG. 19 in an open condition;

FIG. 21 shows the housing of FIG. 19 in a partially open condition;

FIG. 22 shows insulating means located within the housing depicted in FIG. 20;

FIG. 23 shows a wedge pocket located on the exterior of the device;

FIG. 24 shows the wedge pocket in an open position as well as a wedge to be held within the wedge pocket;

FIG. 25 shows a top flap of the device of FIG. 17;

FIG. 26 shows a pocket on the interior of the devise of FIG. 17;

FIG. 27 shows a handle of the device of FIG. 17; first embodiment hose deployment device in a contracted configuration ready to be carried by a user;

FIG. 28 clipping mews of a shoulder strap of the device of FIG. 17;

FIG. 29 is a further exterior view of the device of 17;

FIG. 30 is further exterior view of the device of FIG. 17 with two pockets in an open condition;

FIG. 31 is a further exterior view wherein one pocket of FIG. 30 is shown in an open condition;

FIG. 32 show both pockets of FIG. 30 in an open condition;

FIG. 33 shows a shoulder strap on the exterior of the device of FIG. 17;

FIG. 34 shows a hose securing means with a portion of the hose securing means sheathed in a pocket in the shoulder strap of FIG. 33;

FIG. 35 shows the hose securing means of FIG. 34;

FIG. 36 shows the hose securing means of FIG. 34 removed from the pocket of the shoulder strap with a clip of the hose securing means clipped to a loop;

FIG. 37 shows the hose securing means of FIG. 36;

FIG. 38 shows the house securing means of FIG. 37 with the clip being unclipped from the loop;

FIG. 39 shows an interior of a fourth embodiment hose deployment device in a deployed configuration;

FIG. 40 shows a flap portion of the device of FIG. 39;

FIG. 41 show the flap portion of FIG. 40 in a refracted position;

FIG. 42 shows a closed release flap of the device of FIG. 39 in a contracted configuration;

FIG. 43 shows the release flap of FIG. 42 in an open position;

FIG. 44 shows a coupling holder that is to be secured to the exterior of the device of FIG. 39;

FIG. 45 the coupling holder of FIG. 44 in a compressed configuration;

FIG. 46 shows the coupling holder of FIG. 45;

FIG. 47 shows the coupling holder of FIG. 44 in an expanded configuration;

FIG. 48 shows the coupling holder of FIG. 47 with a flap located in an open condition;

FIG. 49 shows a fifth embodiment hose deployment device in a contracted configuration ready to be carried by a user;

FIG. 50 shows the hose deployment device of FIG. 49 ready to be used;

FIG. 51 shows the device of FIG. 49 in a partially contracted configuration;

FIG. 52 shows the device of FIG. 49 wherein a section of a hose is held in a coiled configuration and another section is held in a flaked configuration;

FIG. 53 shows an enlarged view of a portion of the device of FIG. 49;

FIG. 54 shows the device of FIG. 50; and

FIG. 55 shows a portion of the device of Figure is 54.

### DETAILED DESCRIPTION OF THE PREFERRED EMBODIMENTS

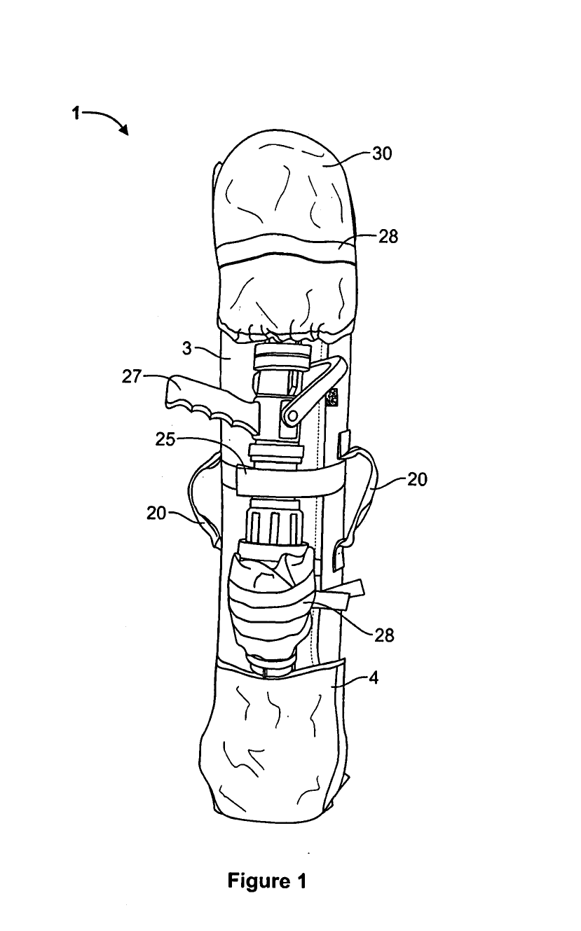

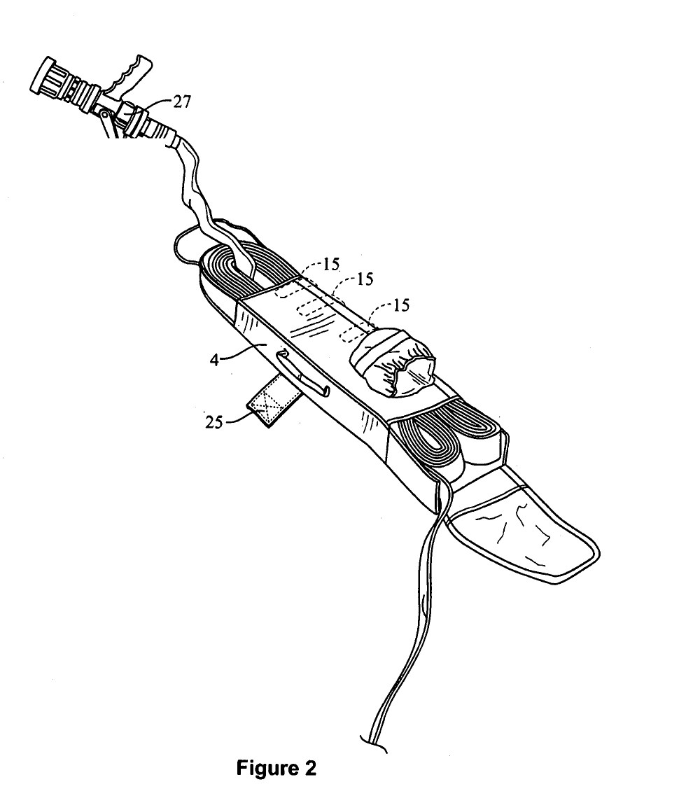

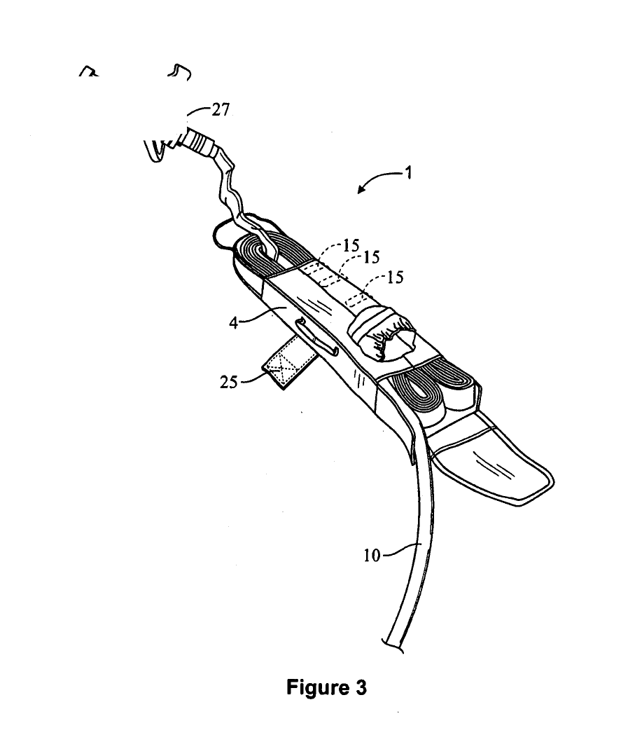

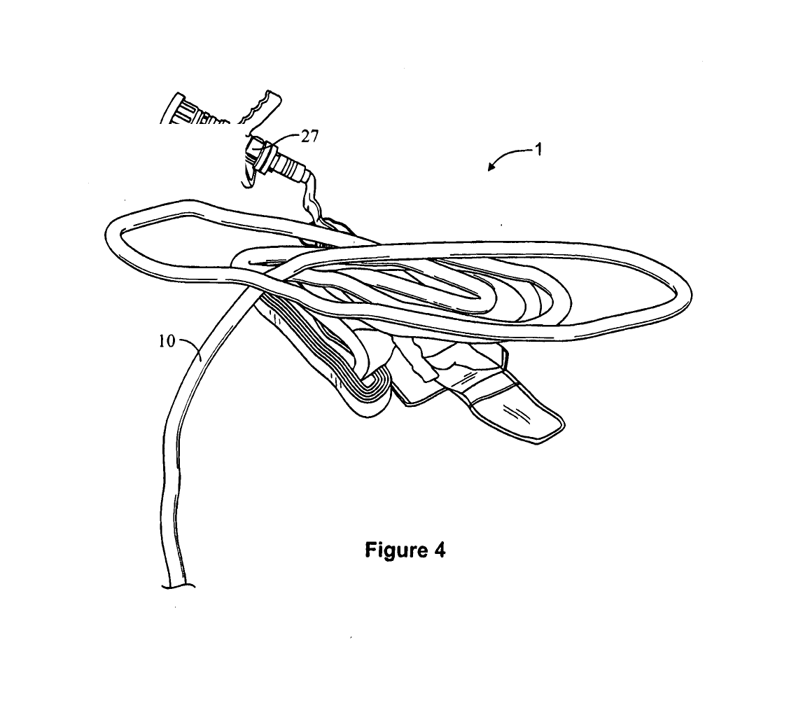

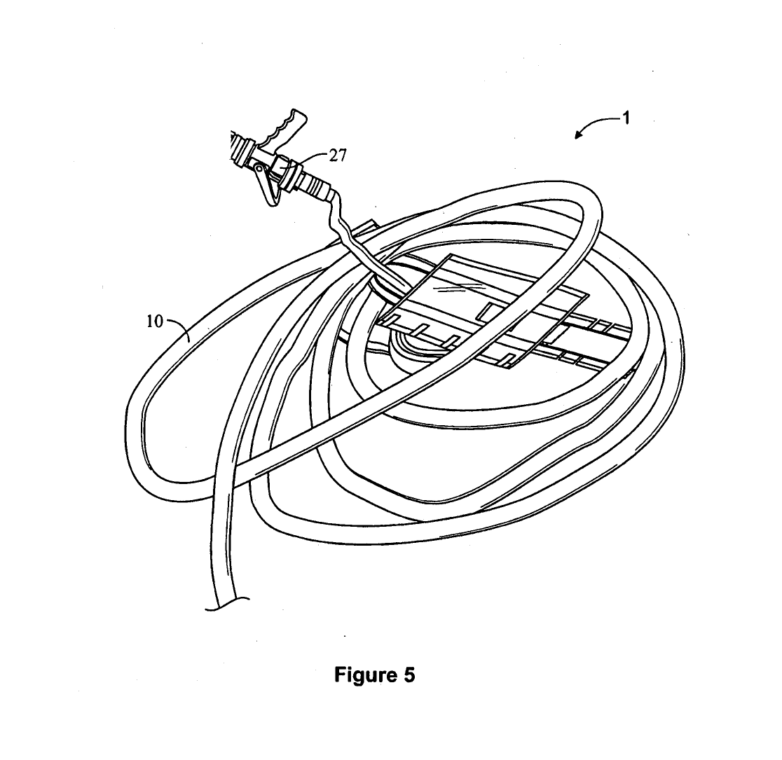

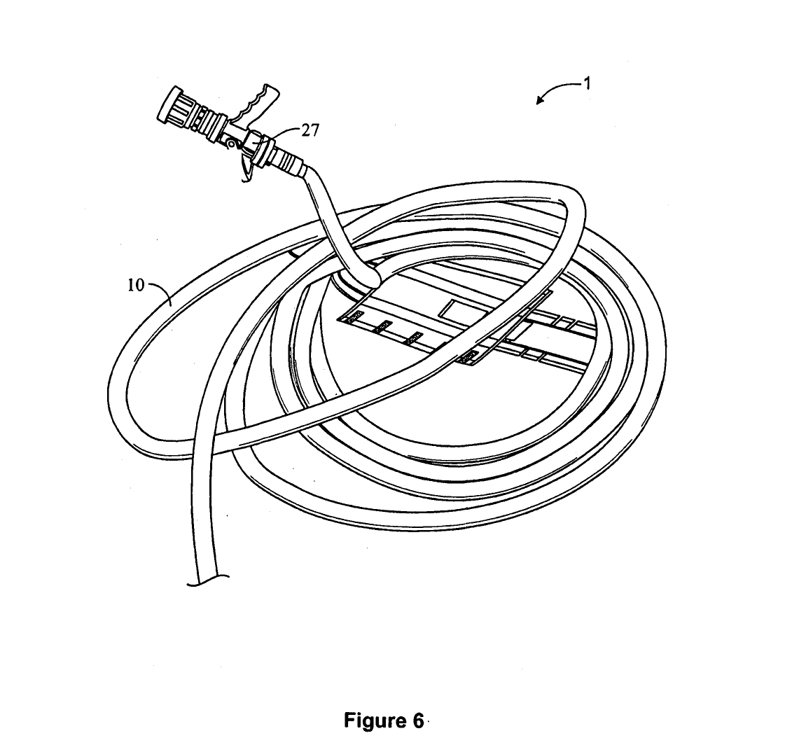

Referring to FIGS. 1 to 9 there is shown a first embodiment hose deployment device 1, including a base 3 having sides 4 which in a contracted configuration (see FIGS. 1 and 2) secure together to define a space to receive a hose 10. The sides 4 in an expanded configuration (see FIGS. 3 to 6) extend outwardly away from each other to provide an opening 6 through which the hose 10 can move. Strap means 12 secure the hose 10 to the base 3 in the contracted configuration, as best seen in FIG. 2. Upon application of a fluid pressure to the inlet valve (not shown), the hose 10 expands urging the strap means 12 to release the hose 10 from the base 3. The hose 10 urges the sides 4 away from each other (as best seen in FIGS. 4 to 6), deploying the hose 10 in a coiled configuration (see FIG. 6) for use by a user. Rather than using pressure the device 1 could also be deployed by a user manually and then pressurized after being laid.

As best seen in FIG. 6, the device 1 can deploy the hose 10 within a small area such as 2 m² in a coiled configuration. This is particularly advantageous in stairwells or the like. The device 1 further includes an additional strap means 15 to secure the sides 4 together until use. In a preferred form, the base 3 is a fabric panel and each side 4 is also a fabric panel extending away from the base 3. The expansion of the hose 10 under pressure will also release the strap means 15, urging the sides 4 to fall apart and away from each other. The device 1 further includes means 20, such as handles, straps or the like so that the device 1 can be carried by a user or attached to a user, such as like a backpack.

In a preferred form, the pressure required at the inlet valve to open the strap means 12, 15 should be more than 400 kPa. The pressure could vary depending upon the size of the device 1 and its uses. In a preferred form, the sides 4 in a contracted configuration overlap each other. The strap means 12, 15 could include hook and loop type fasteners, press-studs or the like. The device could also include a strap or fastening means 25 to hold an outlet nozzle 27 on the device 1 (as best seen in FIG. 1). The device 1 could also include luminescent strips 28 or the like and a top cover 30 could also be provided.

There is also provided herein a method of deploying a hose 10 by a hose deployment device 1. The steps for deploying a hose 10 from the contracted configuration to the expanded configuration. The steps in the preferred form would include carrying the hose deployment device 1 to a location of use, such as a stairwell or the like. Placing the device 1 on a surface and laying out the nozzle 27 and opening the top flap 30 (see FIG. 2). In one embodiment a water source is attached to the water inlet valve (not shown) and the hose 10 is pressurised (see FIG. 3). As the hose 10 is pressurised, the hose 10 expands urging the strap members 12, 15 apart to release the hose 10. The hose 10 urges the sides 4 to fall away from each other (see FIG. 4), deploying the hose 10 in a coiled configuration (see FIG. 6). A user would then carry the nozzle 27 to the location of use towards a fire to be extinguished. Alternatively, the device 1 can be deployed manually by the user moving away front the base 3 rather than being deployed by pressure.

Accordingly, there is shown herein a hose deployment device 1 that deploys a hose 10 reliably, quickly, efficiently and with less movements to current methods and fire fighting procedures. That is, a simple plug and play device 1 with no unrolling, or unkinking. There are also no sharp angles for the water to jamb or kink. The device 1 can be hoisted to a high point or carried to any location. The device 1 can be deployed in tight areas like stairwells or the like, is easily carryable on a back or by hand and provides a fire fighter or other emergency personnel a more strategic option when considering how to fight a fire. As the device 1 only needs to be deployed within about two square meters it can be deployed in a foyer, roof, balcony, stairwell or the like. The device 1 preferably is manufactured of nylon, cotton or the like, however, should include fire resistant material. In the preferred form, the device 1 is made of a number of fabric panels folded together to enclose the hose 10, the panels secured together by straps 12, 15 until use.

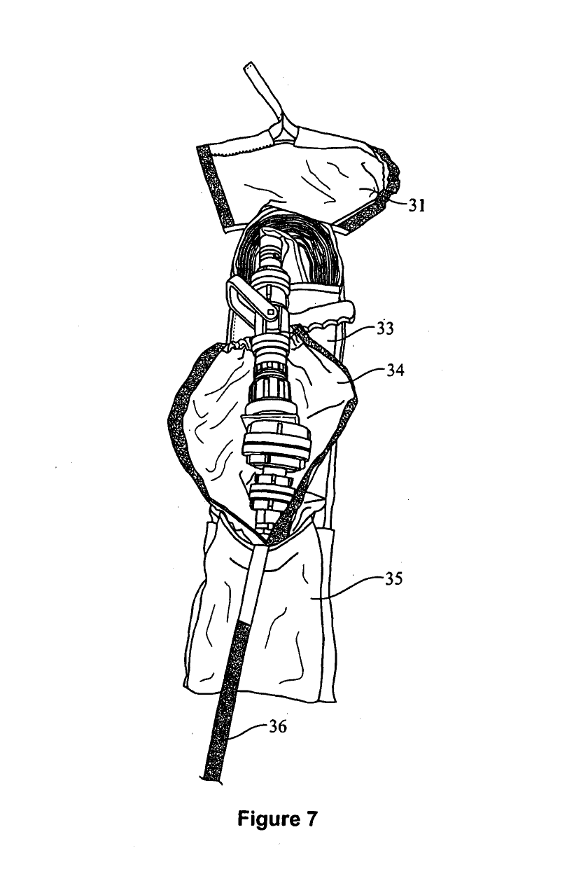

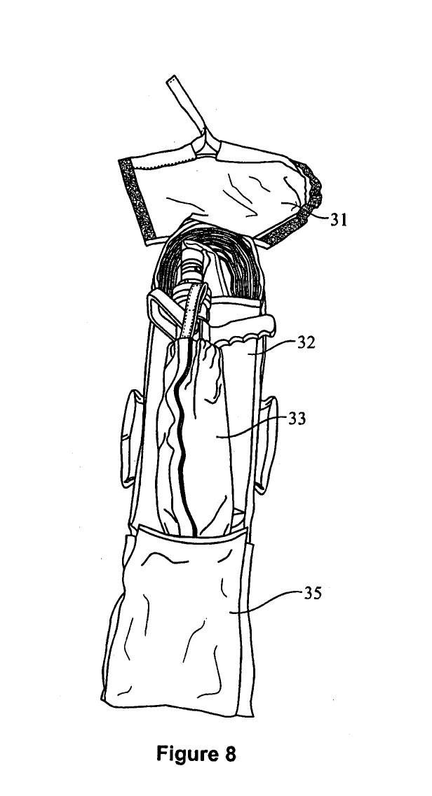

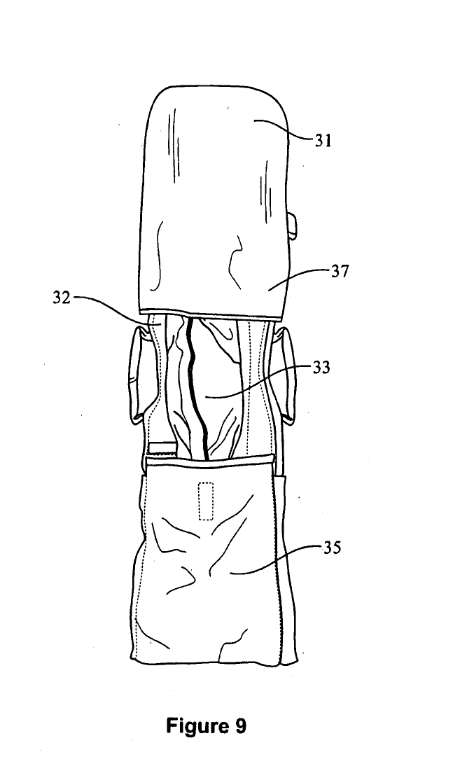

Referring to FIGS. 7 to 9, the device 1 has a mechanism to securely house the hose inlet valve (not shown) and outlet nozzle 27. This housing 33 is purpose built and is secured with hook and loop type fasteners 70 to the device 1. The housing 33 (see FIG. 8 for example) is placed around the hose inlet. The housing 33 has the loop fasteners on both sides 34. A scouring strap 34 is comprised of a strap with hook fasteners. The securing strap 34 is permanently attached to the bottom flap 35. As the bottom flap 35 is closed the securing strap 34 is engaged to both sides of the housing 33. The top flap 31 is closed over the top of the housing 32. The top flap 31 is secured to the side 4 (see FIG. 2) of the device 1. The housing 33 is opened first by pulling strap 37 (see FIG. 9) then pulling securing strap 36 (see FIG. 7).

The device 1 has the ability to contain and reliably deploy a second hose 10 away from a water some to the fire, thus allowing a hose line to be charged and the second hose 10 to coil on the spot. Giving the user the ability to move into the fire effected area more easily.

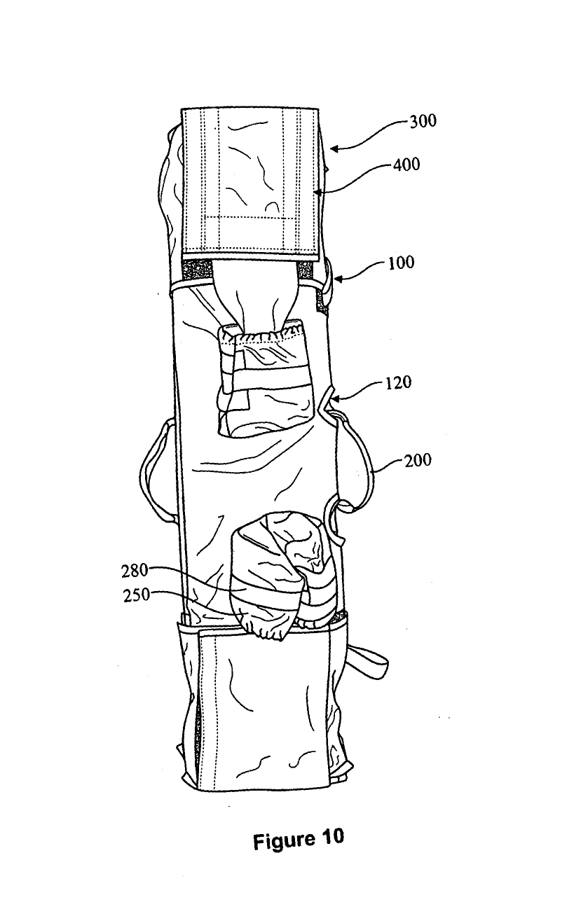

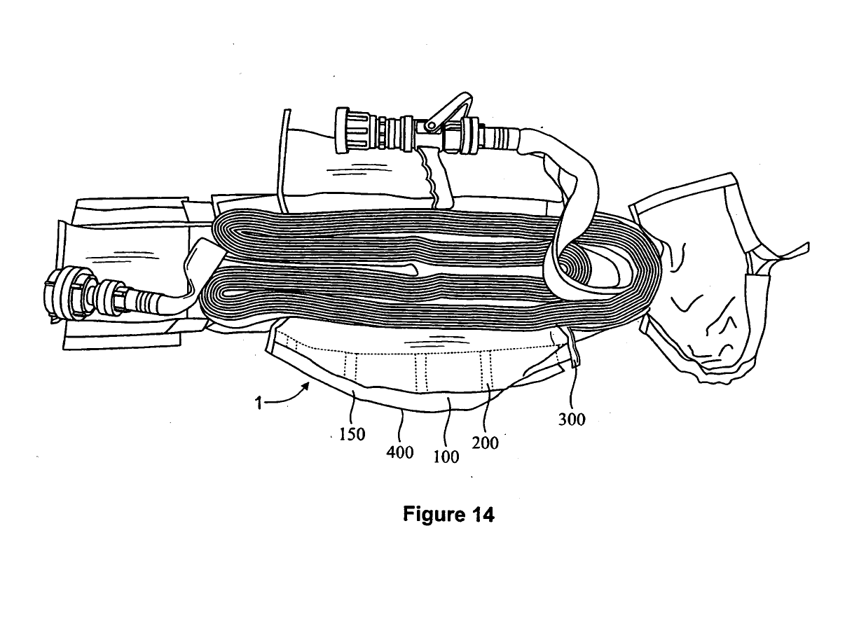

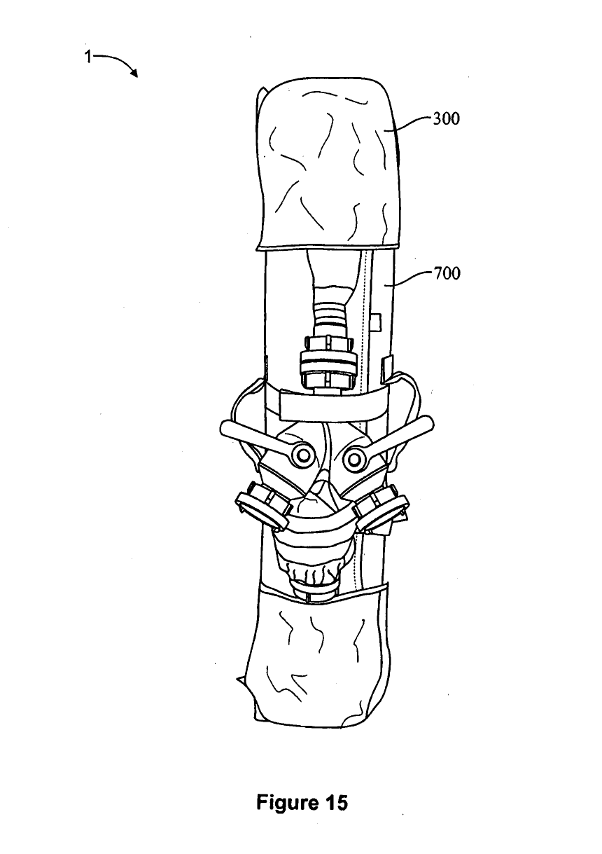

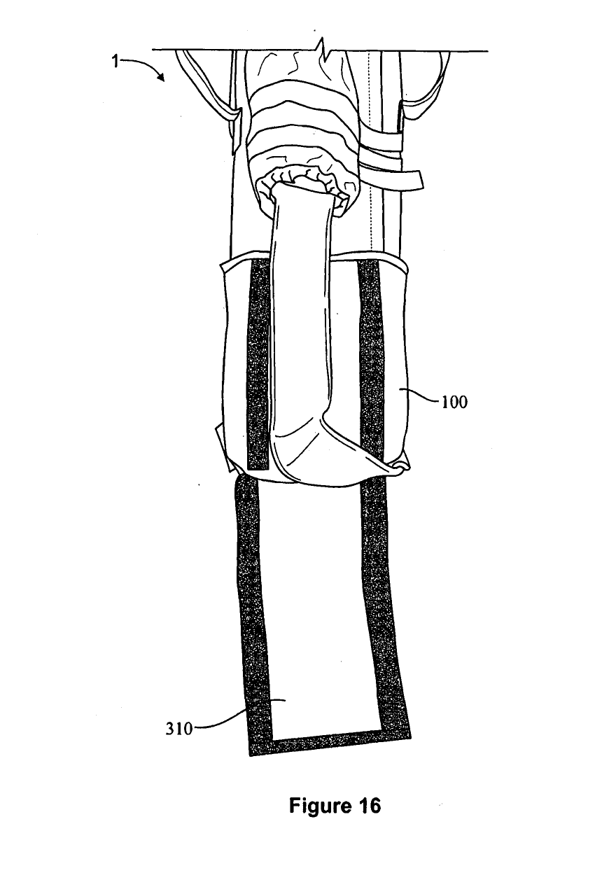

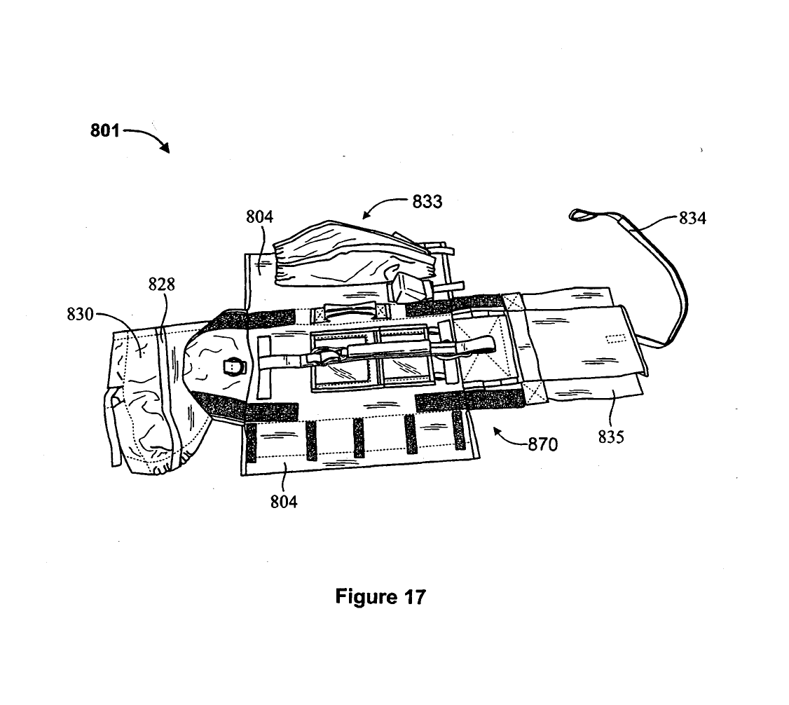

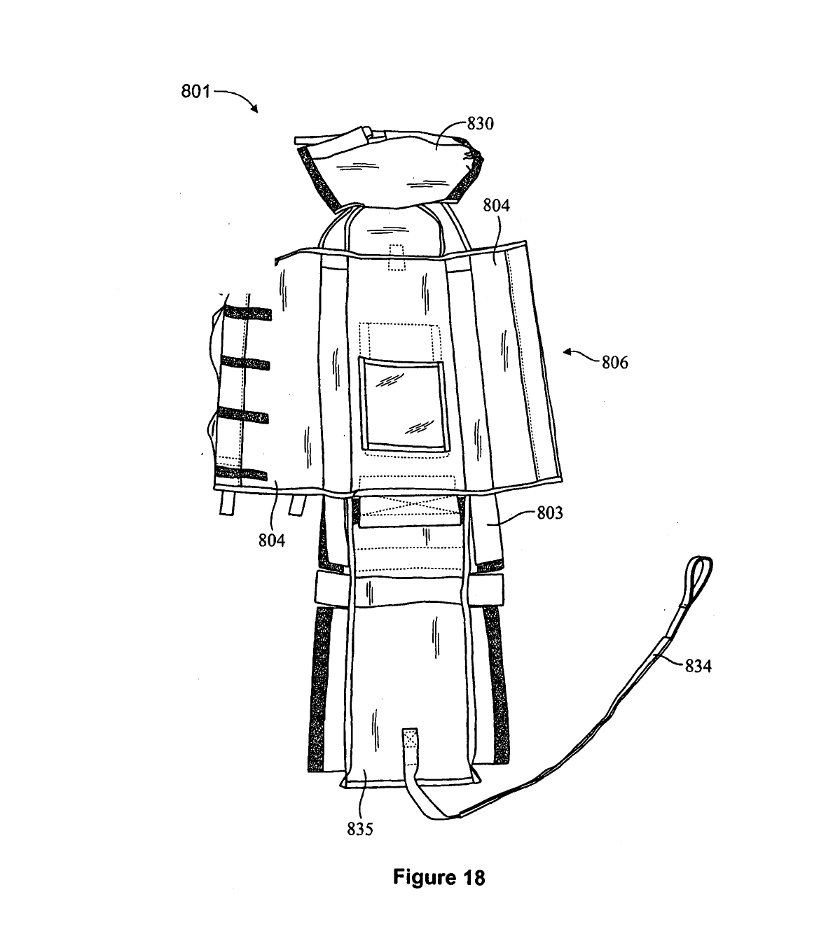

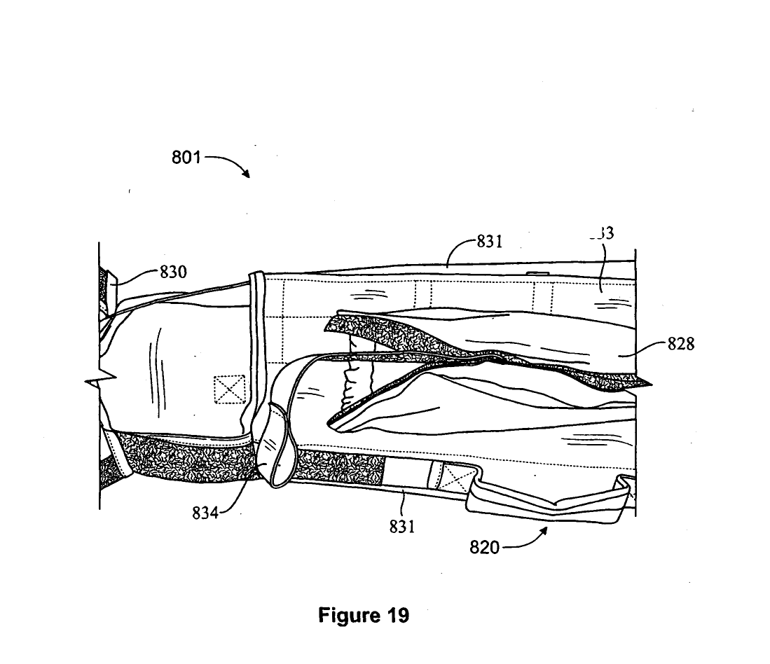

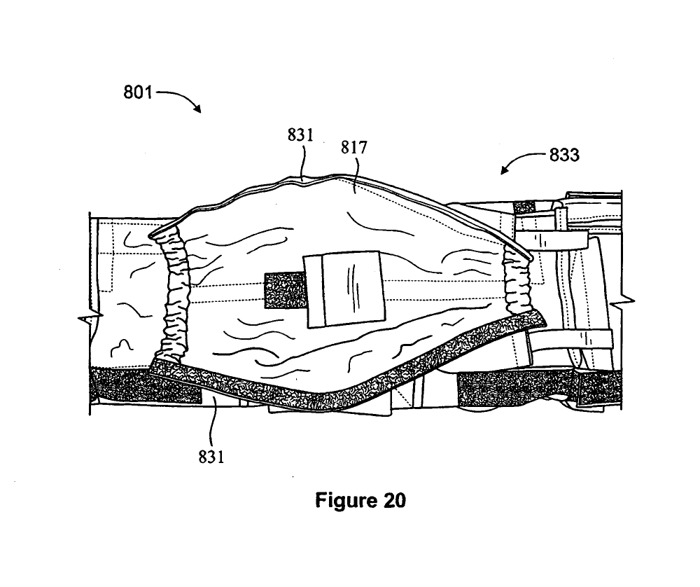

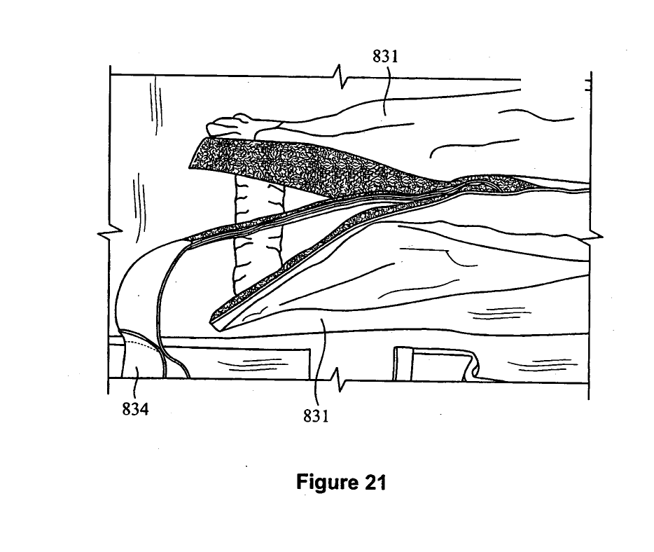

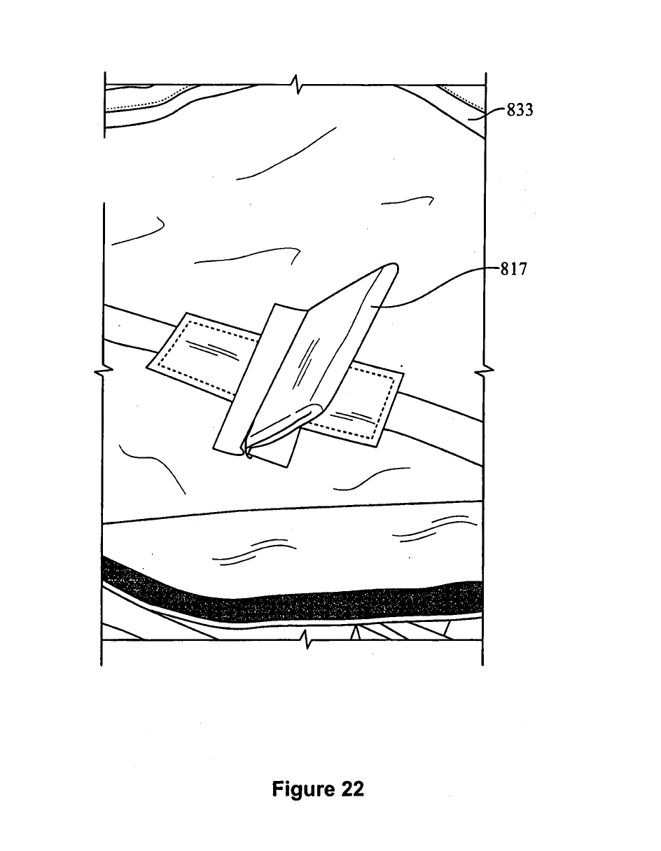

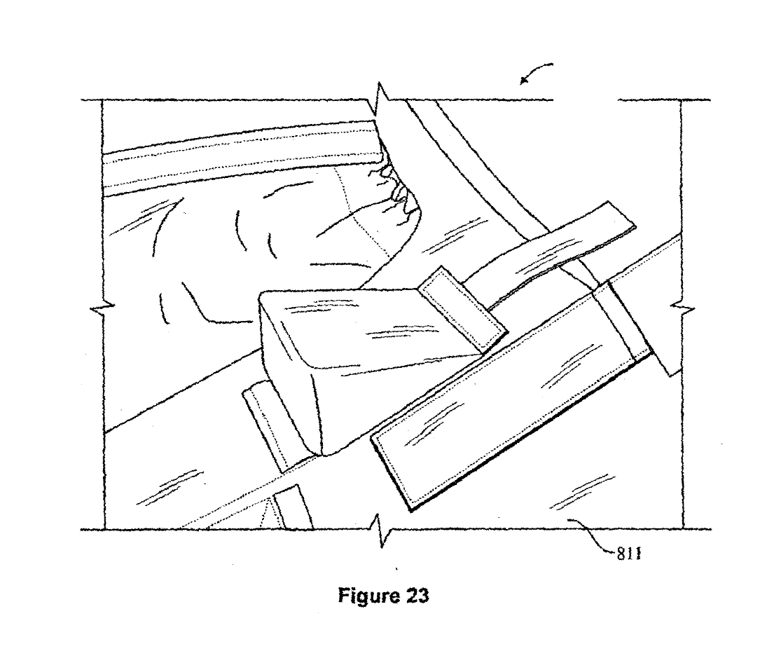

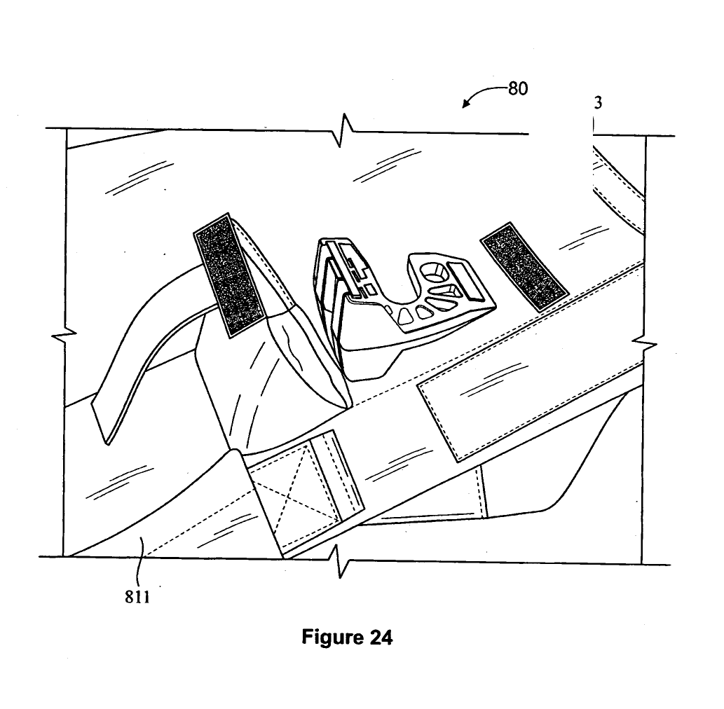

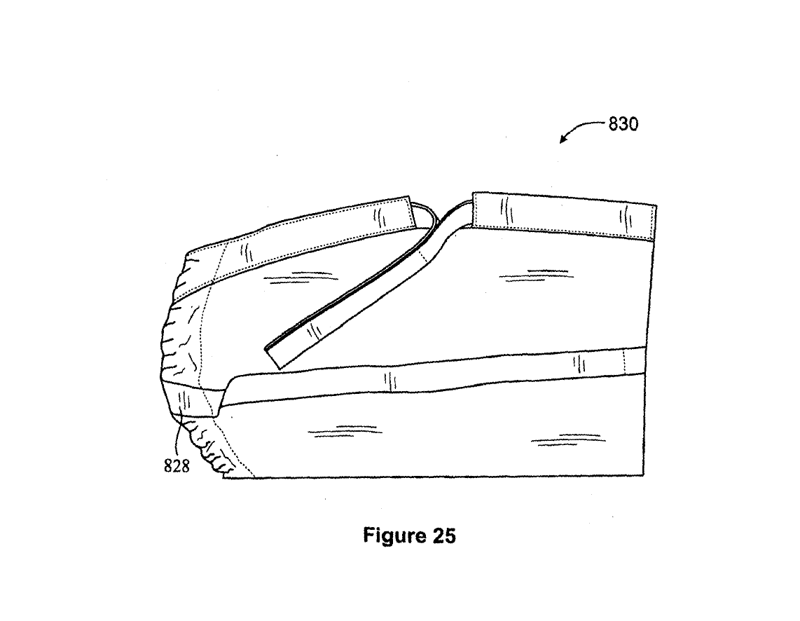

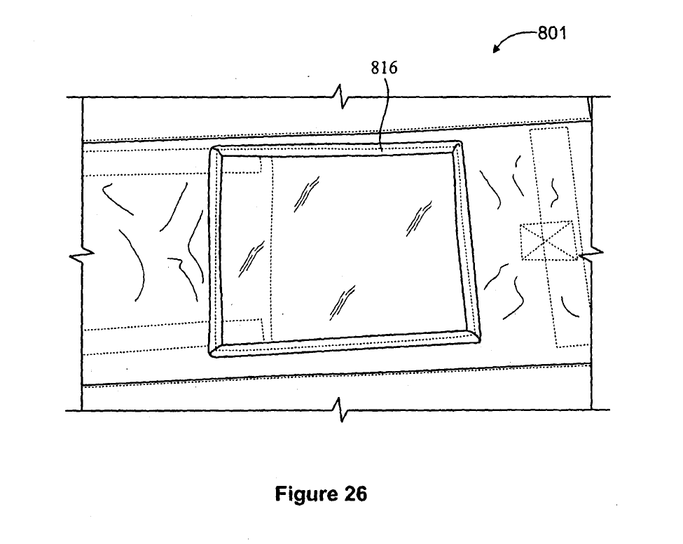

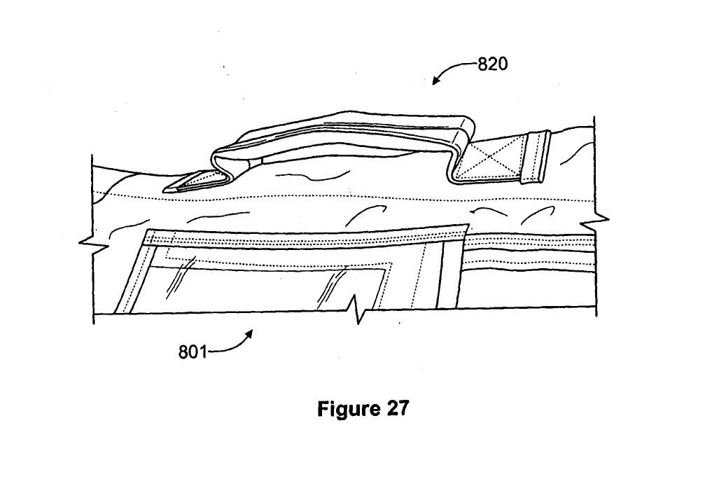

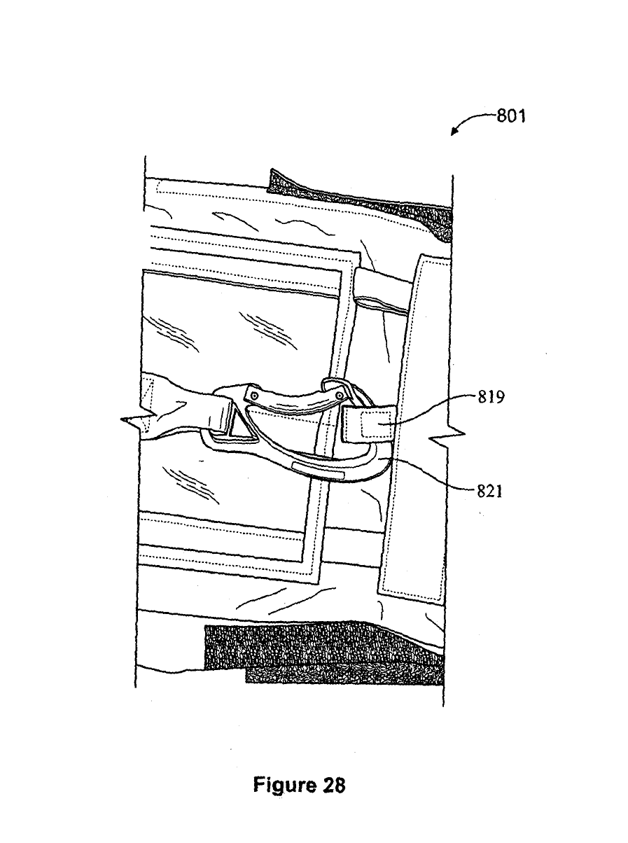

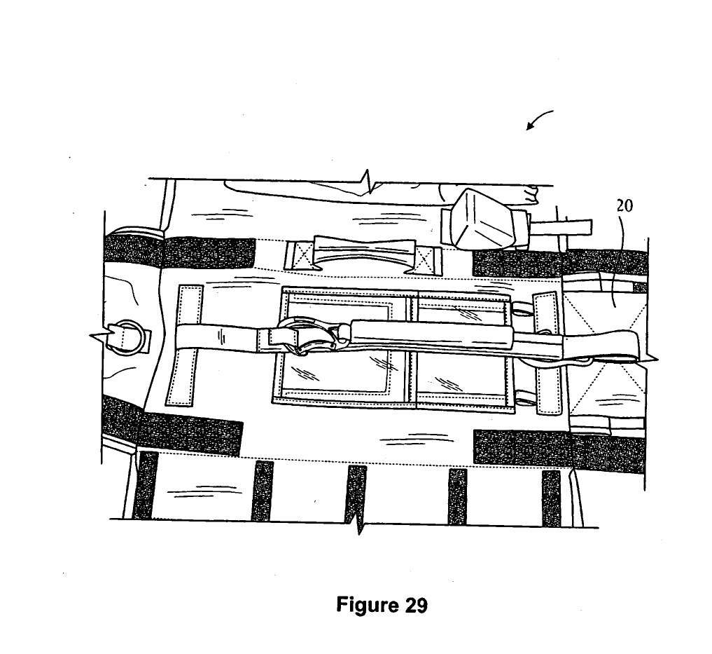

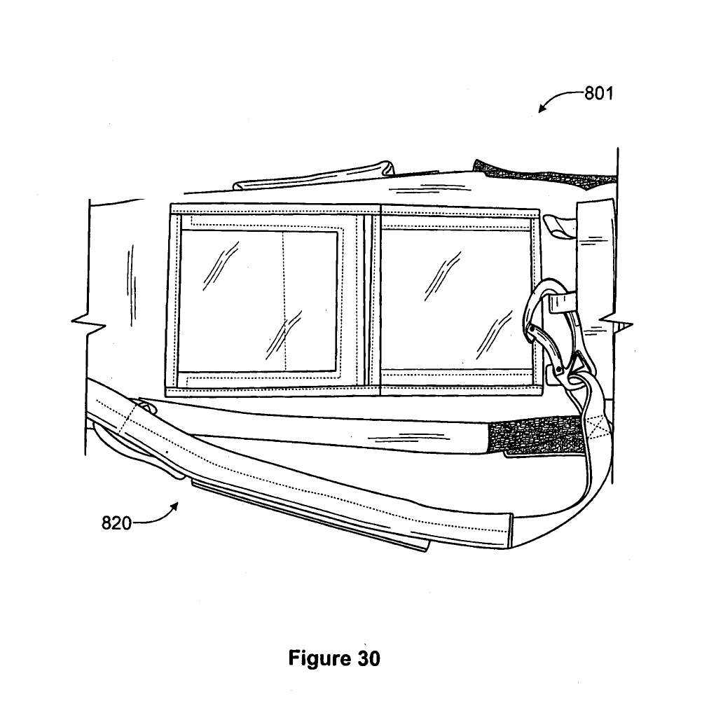

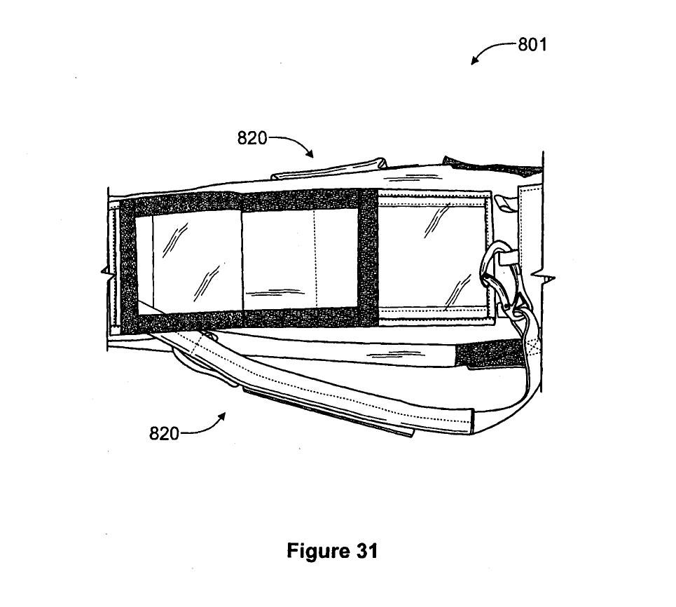

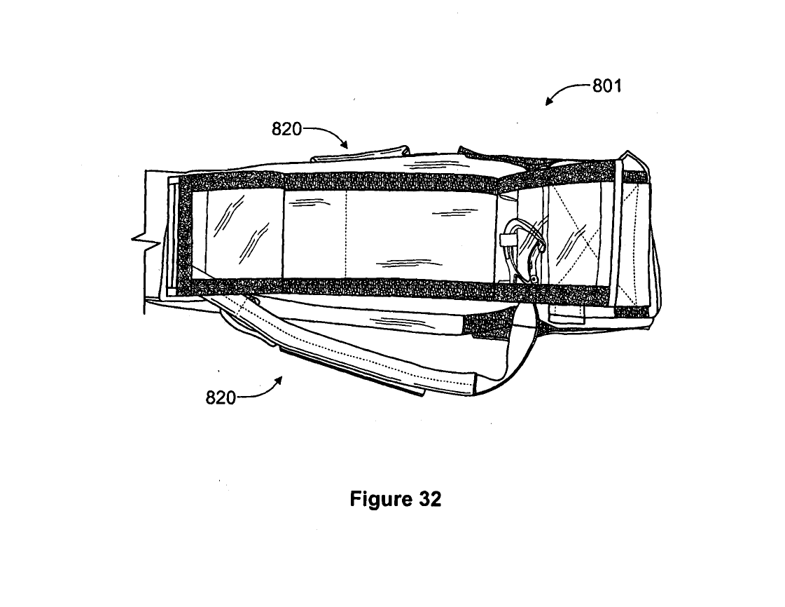

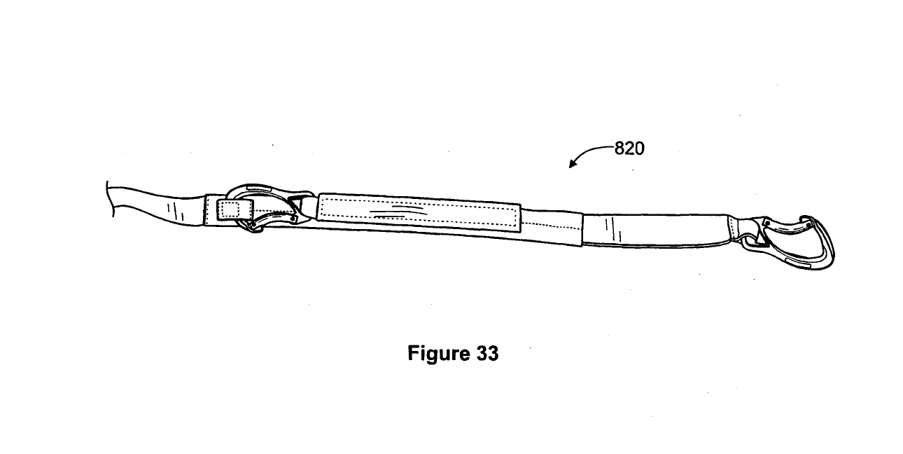

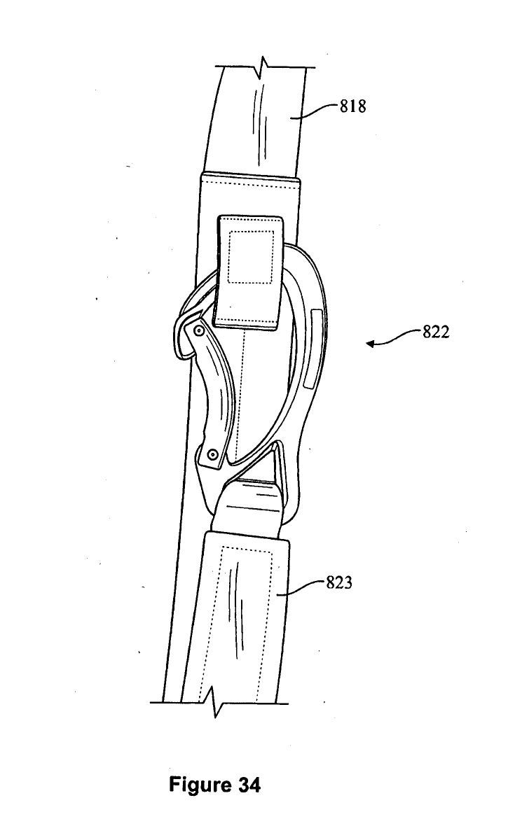

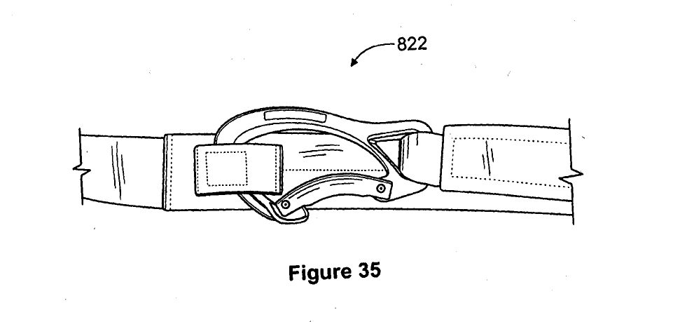

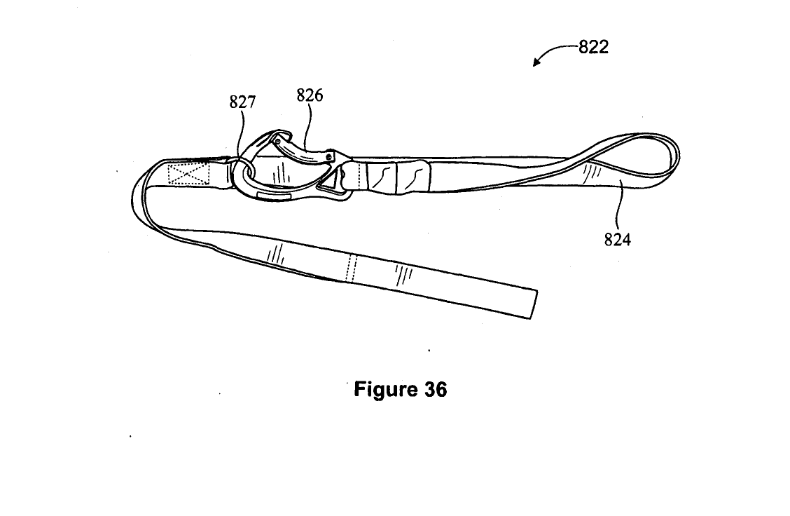

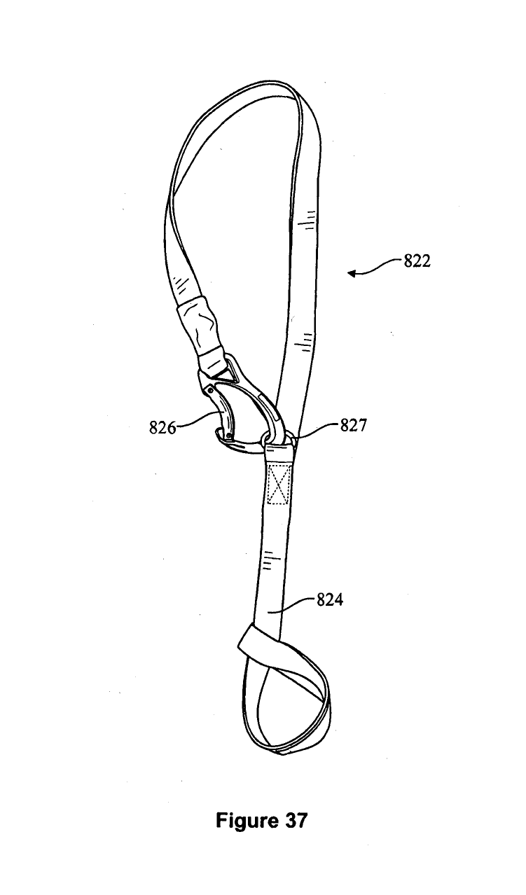

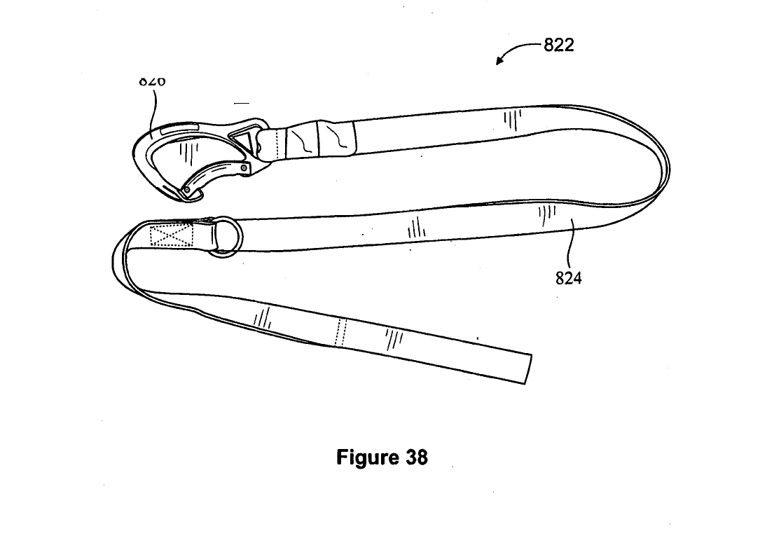

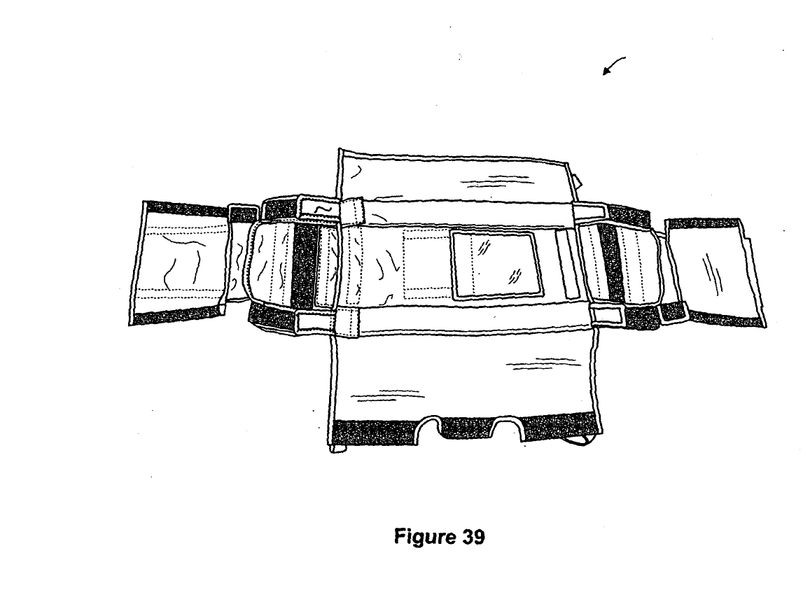

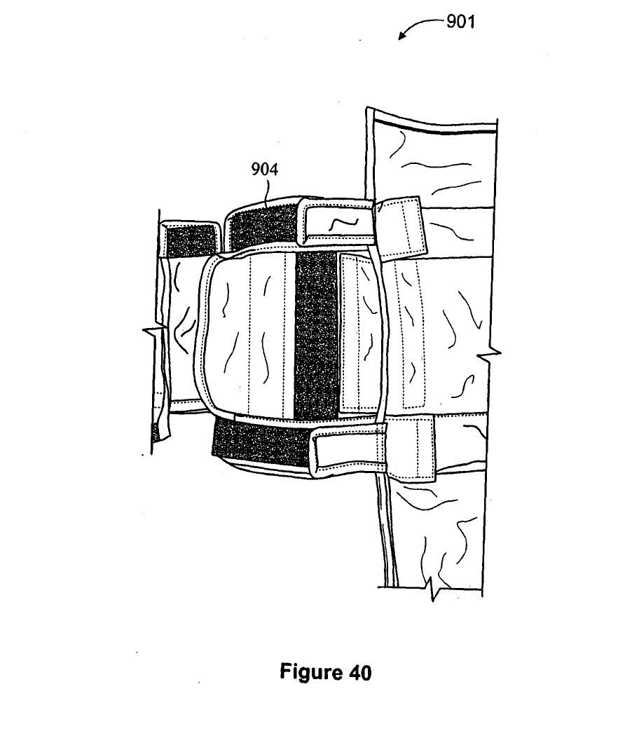

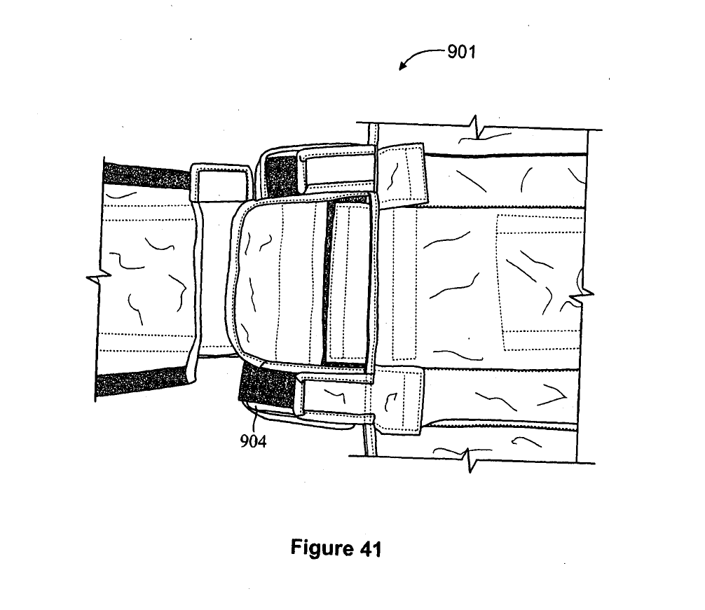

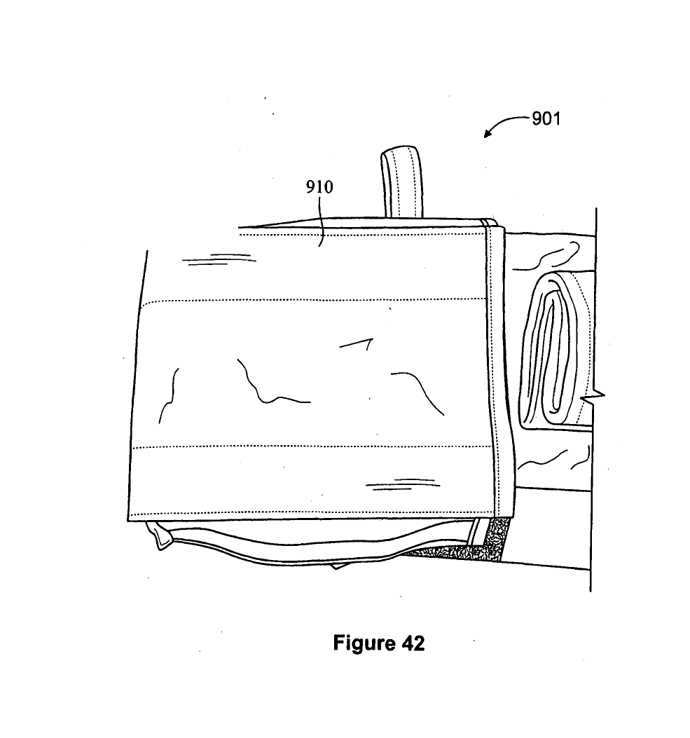

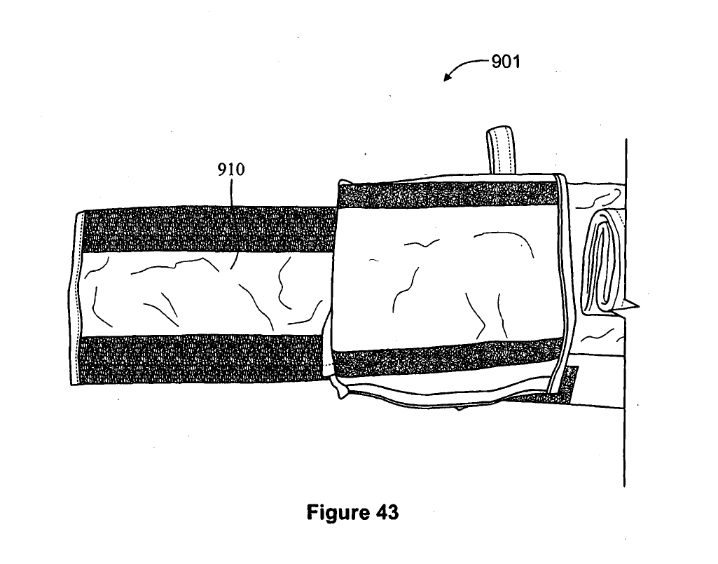

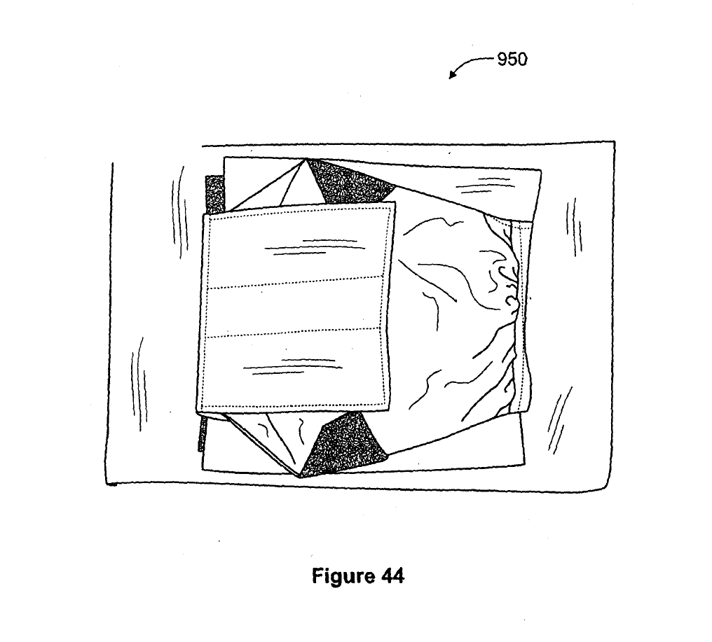

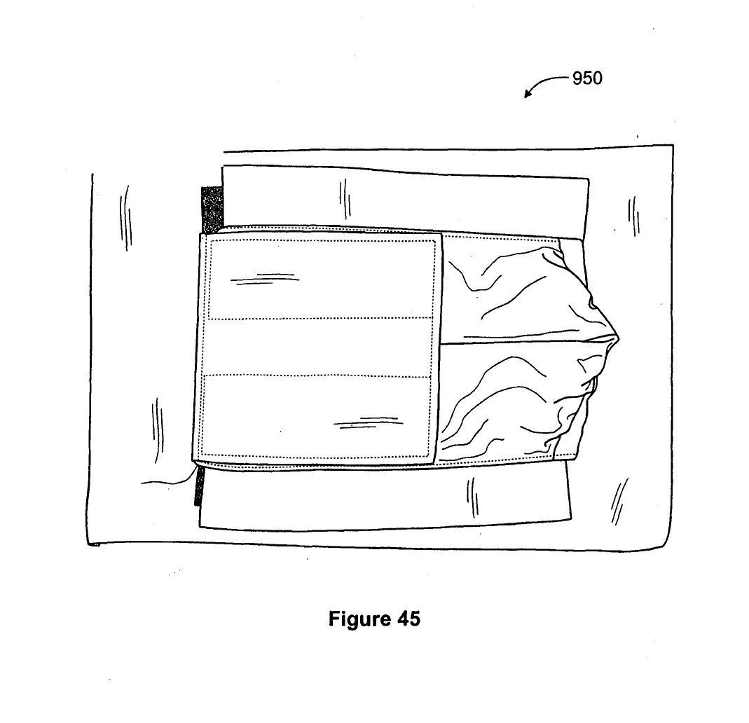

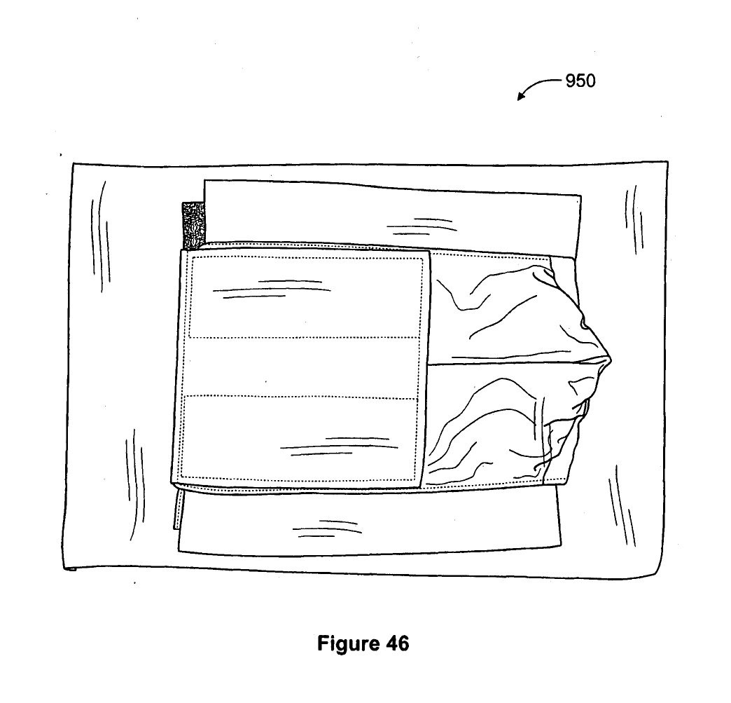

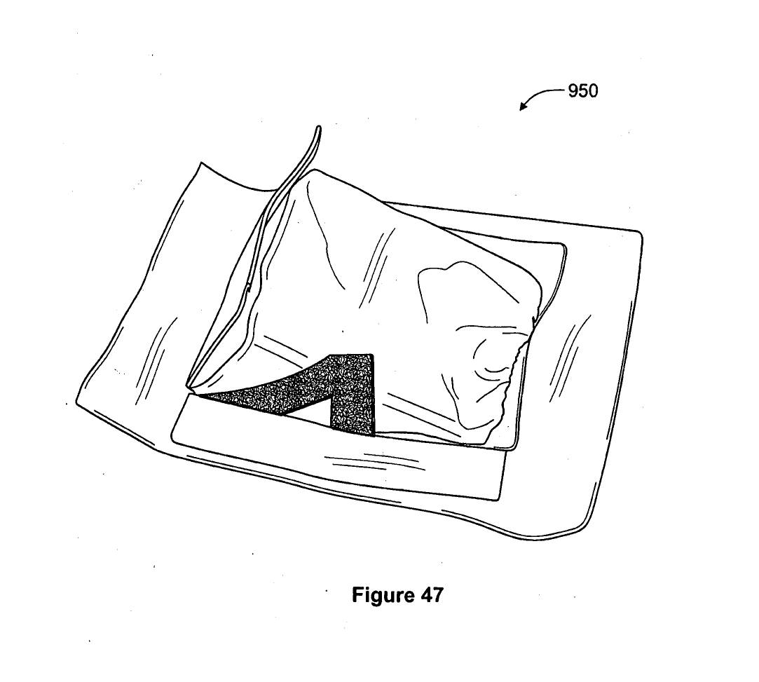

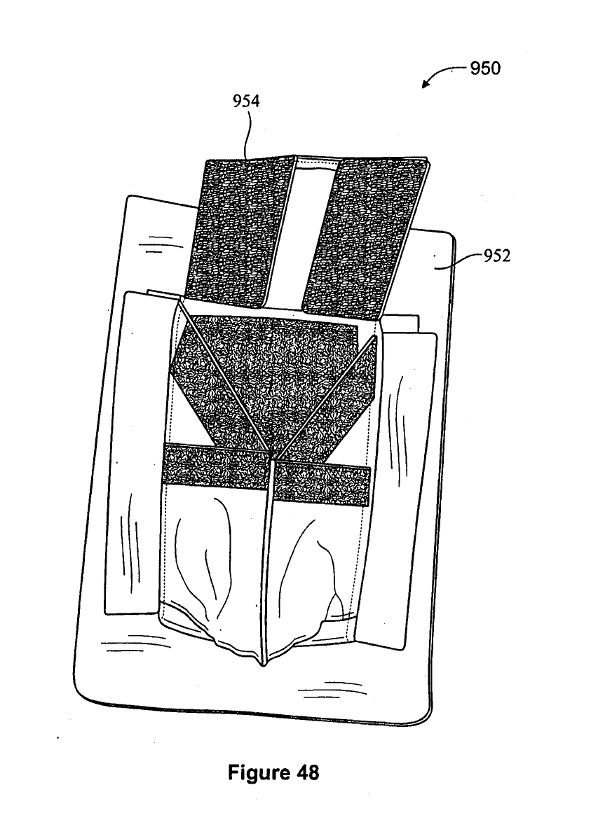

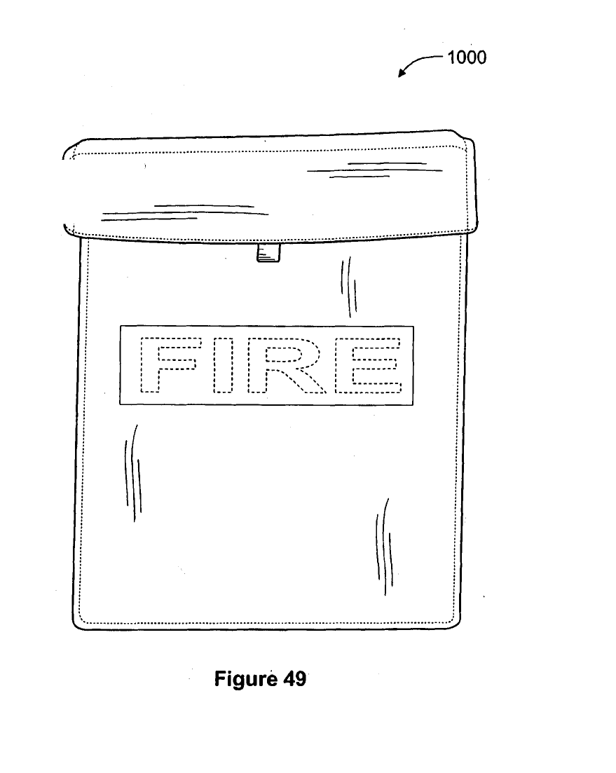

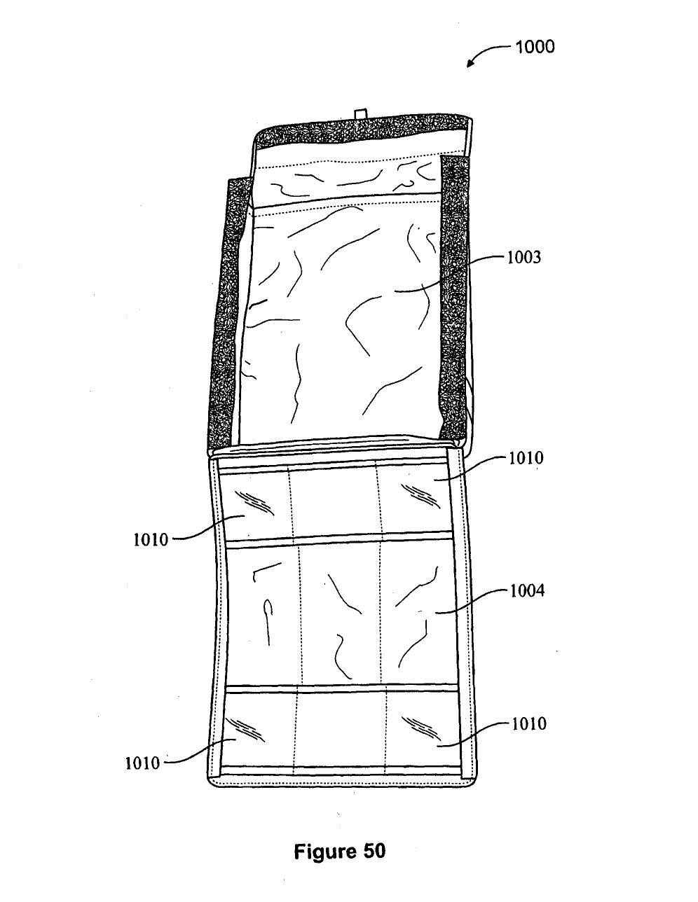

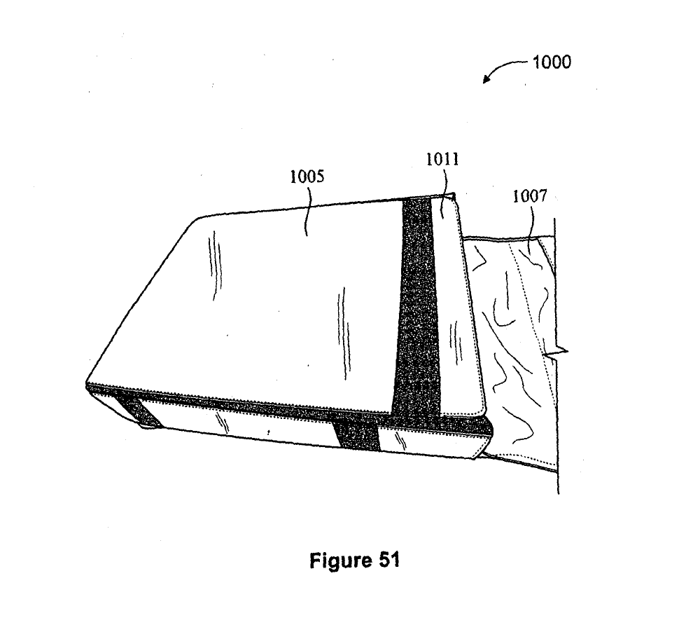

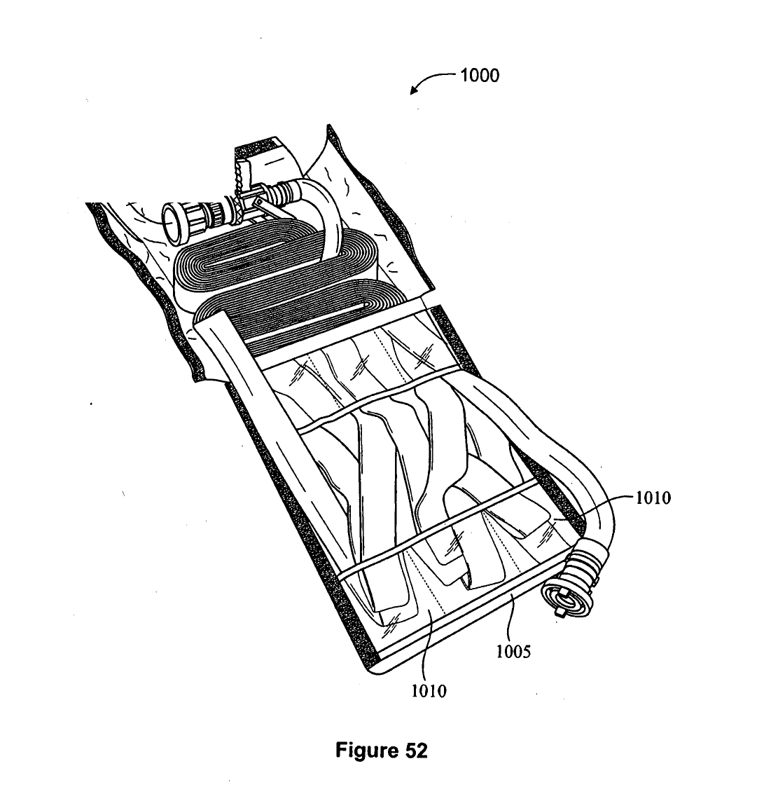

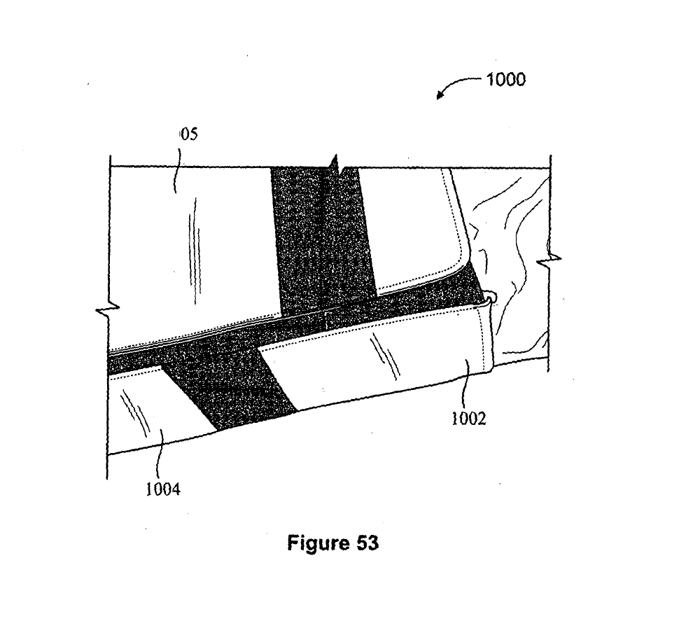

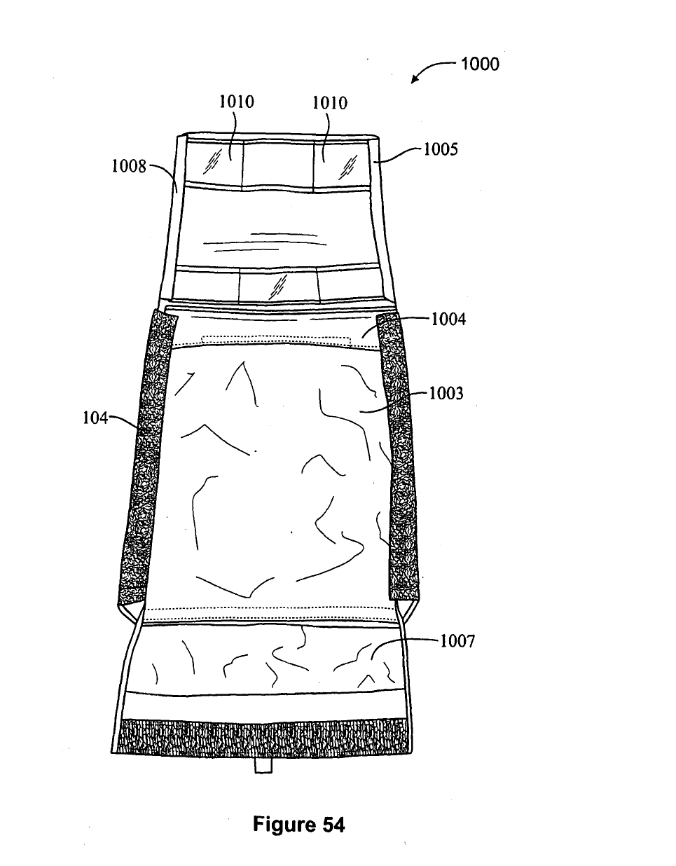

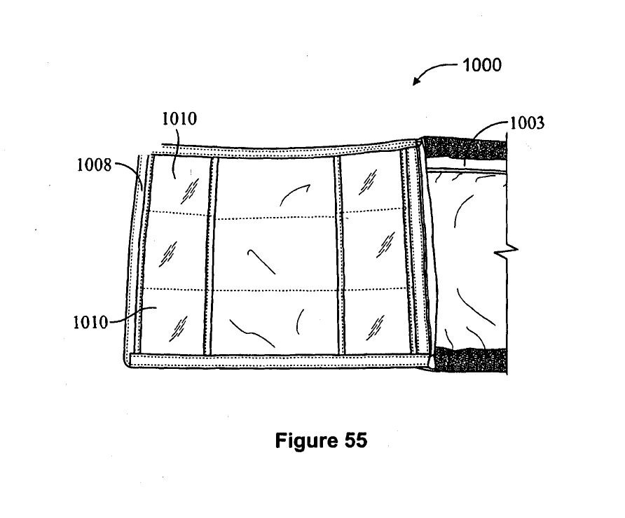

Referring to FIGS. 10 to 16 there is shown a second embodiment hose deployment device 1, including a base 300 having sides 400 which in a contracted configuration (see FIGS. 10 and 11) secure together to define a space to receive a hose 100. Upon disengagement of inlet/outlet valve securing strap 120 the hose 100 is fire to exit the device 1. The device 1 can deploy the hose 100 within a narrow area in a linear configuration. This is particularly advantageous in corridors, up or down stairs or the like. The device 1 further includes an additional strap means 150 to secure the sides 400 together until use. In a preferred form, the base 300 is a fabric panel and each side 400 is also a fabric panel extending away from the base 300. The device 1 further includes means 200, such as handles, straps or the like so that the device 1 can be carried by a user or attached to a user, such as like a backpack.

In a preferred form, the force required to dispatch the hose 100 from the device 1 should be minimal to aid the operator in covering the required area as quickly as possible. In a preferred form, the sides 400 in a contracted configuration overlap each other. The strap means 700, 120, 150 could include hook and loop type fasteners, press-studs or the like. The device 1 could also include a strap or fastening means 250 to hold an optional breeching piece or the like. The device 1 could also include luminescent strips 280 or the like and a top cover 300 and bottom cover 300 could also be provided.

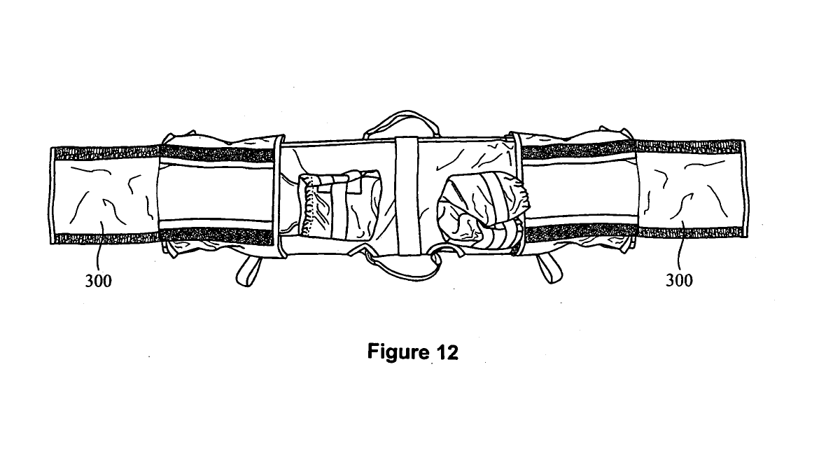

There is also described herein a method of deploying a hose 100 by a hose deployment device 1. The steps for deploying a hose 100 can be seen by proceeding from the contracted configuration to en expanded linear configuration. The steps in the preferred form would include carrying the hose deployment device 1 to a location of use, such as a stairwell or the like. Placing the device 1 on a surface and opening the covers 30 which include inlet/outlet valve hose tail securing flaps 300 (see FIG. 12). As the operator moves from the initial deployment area the hose will automatically deploy in the correct fashion and lay on the travelled surface as the user moves away from the device 1. A user would then connect a nozzle or alternate piece of equipment (for example, a gated wye) 350 or the like to the remaining inlet/outlet valve of the hose 100.

Accordingly, there is shown herein a hose deployment device 1 that deploys a hose 100 reliably, quickly, efficiently and with less movements to current methods and fire fighting procedures. The device 1 is a simple plug and play device 1 with no unrolling, or unkinking, required. There are also no sharp angles for the water to jamb or kink. The device 1 can be hoisted to a high point or carried by a user to any location. The device 1 can be deployed in tight areas such as stairwells or the like, is easy to carry on a back or by hand and provides a fire fighter or other emergency personnel a more strategic option when considering how to fight a fire. The device 1 can also be deployed in a foyer, roof; balcony, stairwell or the like. The device 1 preferably is manufactured of nylon, cotton or the like, however, should include fire resistant material. In the preferred form, the device 1 is made of a number of fabrics panels folded together to enclose the hose 10, the panels secured together by straps 700, 120, 150 until use. The device 1 has a further hose tail flap 310 (see FIG. 16). This flap 310 contains the hose 100 and protects it from the elements. It is removed when the hose 100 is to be deployed. The device 1 is typically carried like a suitcase over a shoulder. The top flap is released and the base is allowed to deploy. The device 1 can store large hoses such as a “supply line”.

The device 1 could include a tracking device (not shown) to locate the fire fighter and/or the hose 10, 100 during operations within buildings, underground or in low visibility. The device 1 could also include audible or visual warning devices 28, 280. This could include a form of identification that could be located within thermal imaging or radio signals. The device 1 could also include a durable, waterproof or different type of material on the base 4, 40 for various uses. A flashing strobe or similar device could also be included.

The device 1 could also include various pockets (not shown) made of various materials to store auxiliary equipment including but not limited to hose spanners, glow sticks or the like. Also the device 1 can include a back strap (not shown) which can be disconnected by carabeena style clips and converted into a purpose built hose securing strap. This is done by passing one end around the hose 100 through a loop on the other end, then tightened into a “larks head” style knot. The free end of the strap can be tied or clipped onto a fire stair, balcony or the like. As the hose 100 exits the device 1 it continually rubs on one spot. A reinforced patch, material or the like (for example leather or plastic) could be included.

Referring to FIGS. 17 to 38 there is shown a third embodiment hose deployment device 801, including a base 803 having sides 804 which in a contracted configuration is secured together to define a space to receive a hose, not shown. The hose will typically be held in a coiled configuration by the device 801 and deployed in a manner similar to the first embodiment described above.

The sides 804 extend outwardly away from each other to provide a deployed configuration 806 allowing the hose to be moved away from the base 803. Strap means, not shown, secure the hose to the base 803 in the contracted configuration.

The device 801 further includes means 820, such as handles, straps or the like so that the device 801 can be carried by a user or attached to a user, such as like a backpack.

The device 801 has a mechanism to securely house a coupling and a nozzle (not shown). This housing 833 is purpose built and is secured with hook and loop type fasteners 870 to the device 801. The housing 833 is placed around the hose inlet. The housing 833 has the loop fasteners on both sides 831. A securing strap 834 is comprised of a strap with hook fasteners. The securing strap 834 is permanently attached to the bottom flap 835. As the bottom flap 835 is closed the securing strap 834 is engaged to both sides of the housing 833. The housing 833 is opened by pulling the securing strap 834 to separate the respective hook and loop fasteners.

The device 801 includes wedge pockets 811 to store wedges 813 (shown in FIGS. 23 and 24). The device 801 further includes a pocket 816 to hold, for example, operating instructions. Insulating means 817 (shown in FIG. 22), which in use will insulate/separate the coupling from the nozzle, is provided to protect the nozzle within the housing 833.

The device includes a shoulder strap 818 which is scoured to a loop 819 via a clip 821 as shown in FIGS. 28 to 35. A hose securing means 822, shown in FIGS. 36 to 38 is sheathed within a pocket 823 within the shoulder strap 818. The hose securing means 822 comprises a strap 824 with a clip 826 and loop 827. The clip 826, here a D-clip, and loop 827 can, for example, be used to secure a section of a hose to a railing when the hose is to be suspended from the railing.

A fourth embodiment hose deployment device 901 is shown in FIGS. 39 to 43. The device 901 operates in a manner similar to the second embodiment described above. The device 901 houses a flaked hose which is deployed by having a user puling sections of the hose from the device as the user carries the device 901 across a distance. To deploy the hose, a release flap 910 is moved from a closed position, shown in FIG. 42, to an open position, shown in FIG. 43.

The device 901 in particular includes opposing sides, one of which is shown and depicted with the reference numeral 904, extendable between a retracted position, shown in FIG. 41 and an extended position, shown in FIG. 40. By having such extendable sides it is possible to increase the volume of the device 901.

FIGS. 44 to 48 show a coupling holder 950 that is to be secured to the exterior of the device 901. The coupling holder 950 is shaped as shown and is adapted to secure a hose coupling to the device 901. The coupling bolder 950 can be folded from a compressed configuration, shown in FIGS. 44 to 46, to an expanded configuration, shown in FIGS. 47 and 48, when a coupling is to be secured therein. In the expanded configuration the coupling holder 950 provides a pocket 952 which is dosed with a flap 954.

FIGS. 49 to 55 show a fifth embodiment hose deployment device 1000. The device includes a base 1003, sides 1004 which extend from the base, a cover 1005 secured to a side 1004, and a closure 1007 extending from the base. The base 1003 and sides 1004 define a holding area in which a section of a hose is in use held, preferably in a coiled configuration. The cover 1005 includes hose holding means 1008. The holding means of this embodiment comprises two rows of opposing pockets 1010, each row including a number of pockets. In use a section of the hose is held, in a flaked configuration between the rows of pockets. This is shown in FIG. 52.

As shown in FIG. 51, the closure 1007 is secured to the cover 1005 with a hook and loop fastener arrangement 1011. FIG. 53 in turn shows that the cover 1005 is secured to the sides 1004 with a hook and loop fastener arrangement 1012.

The device 1000 is preferably compact in size so as to be stored within a container located at a fire hydrant.

Although the invention has been described with reference to specific examples, it will be appreciated by those skilled in the art that the invention may be embodied in many other forms.

1. A hose deployment device including:
a base having sides which In a contracted configuration secure together to define a space to receive a hose, the sides in an expanded configuration extend outwardly away from each other to provide an opening through which the hose can move;
fastening means to secure a hose inlet valve and a hose outlet nozzle to said device;
strap means to secure a hose to the base in the contracted configuration; and
whereby upon application of a fluid pressure to said inlet valve, said hose expands urging said strap means to release said hose from said base, said hose urging said sides away from each other deploying said hose into a coiled configuration for use by a user.

2. The hose deployment device according to claim 1, wherein said coiled configuration is within a 2 m² area.

3. The hose deployment device according to claim 1, wherein said hose is deployed from said device in a coiled configuration until such time as a user moves the hose away from the device.

4. The hose deployment device according to claim 1, wherein pressure in said inlet valve to release said strap means is more than 400 KPa.

5. A method of deploying a hose including the steps of:
carrying a hose deployment device according to claim 1 to a location of use;
placing the device on a surface;
attaching a water source to said water inlet valve;
pressurizing said hose so that said hose expands;
said pressurized hose, urging said strap means to release said hose from said hose, said hose urging said sides away from each other deploying said hose in a coiled configuration;
a user moving said outlet nozzle towards a fire to be extinguished, straightening said hose.

6. A hose deployment device including:
abuse having sides which in a contracted configuration secure together to define a space to receive a hose, the sides in an expanded configuration extend outwardly away from each other to provide an opening through which the hose can move;
fastening means to secure a hose inlet valve and a hose outlet valve to said strap means to secure the hose to the base in the contracted configuration;
securing straps connected to said fastening means and strap means; and
whereby upon a user urging said securing straps said hose valves are released from said device and said hose can be deployed.

7. The hose deployment device according to claim 1, wherein said device in the contracted configuration can be deployed in any space the size of the device or greater.

8. The hose deployment device according to claim 1, wherein said hose is adapted to be deployed from said base in a linear configuration to avoid kinking,

9. The hose deployment device according to claim 1, wherein strap means to secure said sides together.

10. The hose deployment device according to claim 1, wherein said device includes means to attach said device to a user.

11. The hose deployment device according to claim 1, wherein said sides in the contracted configuration overlap each other.

12. The hose deployment device according to claim 9, wherein said strap means includes a hook and loop type fastener.

13. (canceled)

14. A method of deploying a hose including the steps of:
carrying a hose deployment device according to claim 6 to a location of use;
placing the device on a surface;
opening an inlet/outlet valve securing strap on said device;
removing the inlet/outlet valve of contained hose; and
manually removing hose front an end of said device to deploy said hose.

15. The hose deployment device according to claim 6, wherein said device in the contracted configuration can be deployed in any space the size of the device or greater,

16. The hose deployment device according to claim 6, wherein said hose is adapted to be deployed from said base in a linear configuration to avoid kinking,

17. The hose deployment device according to claim 6, wherein strap means to secure said sides together.

18. The hose deployment device according to claim 6, wherein said device includes means to attach said device to a user.

19. The hose deployment device according to claim 6, wherein said sides in the contracted configuration overlap each other.
